(19) United States
(12) Patent Application Publication
(10) Pub. No.: US 2009/0067874 A1
(43) Pub. Date: Mar. 12, 2009

(54) Charging device, process cartridge, image forming apparatus, and cleaning member

(75) Inventor: Takuro Hoshio, Minamiashigara (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/081,006

(22) Filed: Apr. 9, 2008

(30) Foreign Application Priority Data
Sep. 7, 2007 (JP) 2007-232311

(51) Int. Cl. G03G 15/02

(52) U.S. Cl. 399/100

(57) ABSTRACT

A charging device includes a charging member that gives an electric charge to an object to be charged by contacting the object, and a cleaning member that cleans the charging member by contacting the charging member. The cleaning member includes a base formed of a polymer material having a foamed structure and a covering film. The covering film is formed of a mixture of a resin having a crosslinked structure and electroconductive particles and covers, near a surface of the base, a structural wall of the formed structure.

This application is based on and claims priority under 35USC 119 from Japanese Patent Application No. 2007-232311 filed Sep. 7, 2007.

### BACKGROUND

(i) Technical Field

The invention relates to a charging device for giving an electric charge to an object to be charged, a process cartridge having an image carrier, an image forming apparatus for forming an image on a recording medium, and a cleaning member having a base formed of a polymer material.

(ii) Related Art

In recent years, image forming apparatuses such as printers and copiers become widely used, and techniques relating to various elements forming such image forming apparatuses also become widely used. Among the image forming apparatuses, a majority of image forming apparatuses using an electrophotographic system form a print pattern by charging an image carrier with a charging device and then forming, on the charged image carrier, an electrostatic latent image having a different potential from that of its surrounding area, and the electrostatic latent image thus formed is developed with a toner-containing developing agent and finally transferred onto a recording medium. Recently, a process cartridge provided therein with constituent elements of an image forming apparatus, such as an image carrier and a charging device, is traded in the market, and by integrating this process cartridge in an image forming apparatus, the image forming apparatus can be provided all at once with a plurality of constituent elements including an image carrier and a charging device, thus facilitating maintenance etc.

The charging device is a device playing an important role in charging an image carrier and is roughly divided into 2 types of charging devices: (1) a charging device in a contact-charging system which is in direct contact with an image carrier thereby charging the image carrier and (2) a charging device in a non-contact-charging system which without contacting an image carrier, charges the image carrier by corona discharge in the vicinity of the image carrier. In the charging device in a non-contact-charging system, substances such as ozone or nitrogen oxides may be secondarily formed. Thus, use of charging devices using a contact-charging system is increasing.

The charging device in a contact-charging system is provided with a charging member that is in direct contact with the surface of an image carrier and rotated following the movement of the surface of the image carrier to charge the image carrier. When the image carrier is charged, a toner on the image carrier or an external additive for the toner adhere often to the charging member, and the resistance (surface resistance) of the surface of the charging member may be varied by such adhering matter, to destabilize charging performance. Accordingly, in the charging device in a contact-charging system, the surface of the charging member should be provided with a mechanism of cleaning the surface of the charging member, and charging devices using a system of cleaning the surface of a charging member with a cleaning member abutting on the rotating charging member are often used.

The material of a cleaning member used in a charging device is a material having hardness and elasticity suitable for cleaning the surface of a charging member, preferably a polymer material having a foamed structure by which a matter adhered onto the surface of the charging member is easily scraped away. Such polymer material includes, for example, resin foams such as urethane foam. However, such a polymer material is a material having a foamed structure so that when used as a material of the cleaning roll body, foreign substances such as abrasive powder generated in a process for producing a cleaning member are often incorporated into the cleaning roll body. The cleaning member is always abutted on a rotating charging member, thus easily charging foreign substances by static electricity friction (frictional electrification) generated upon abutting on the rotating charging member, and the charged foreign substances are transferred by electrostatic force from the cleaning member to the surface of the charging member, and adhere to the surface of the charging member. This may deteriorate the charging performance of the charging member.

### SUMMARY

A charging device according to an aspect of the present invention includes: a charging member that gives an electric charge to an object to be charged by contacting the object; and a cleaning member that cleans the charging member by contacting the charging member, wherein the cleaning member has a base formed of a polymer material having a foamed structure and a covering film that is formed of a mixture of a resin having a crosslinked structure and electroconductive particles and that covers, near a surface of the base, a structural wall of the formed structure.

### BRIEF DESCRIPTION OF THE DRAWINGS

Exemplary embodiments of the invention will be described in detail based on the following figures, wherein:

FIG. 1 is a whole block diagram of one exemplary embodiment of the image forming apparatus of the present invention;

FIG. 2 is an external view of a part of a charging device shown in FIG. 1;

FIG. 3 is a sectional view of the charging device in FIG. 2;

FIG. 4 shows the surface of a cleaning roll;

FIG. 5 is a schematic sectional view of a layer structure of the image carrier shown in FIG. 1;

FIG. 6 shows a layer structure of an image carrier that is a modification to the image carrier shown in FIG. 1;

FIG. 7 shows a layer structure of an image carrier that is a modification to the image carrier shown in FIG. 5;

FIG. 8 shows a layer structure of an image carrier that is a modification to the image carrier shown in FIG. 5;

FIG. 9 shows a layer structure of an image carrier that is a modification to the image carrier shown in FIG. 5;

FIG. 10 shows a schematic block diagram of an image forming apparatus in a rotary system corresponding to another exemplary embodiment of the image forming apparatus of the invention; and

FIG. 11 is the whole block diagram of a monochromatic image forming apparatus corresponding to still another exemplary embodiment of the image forming apparatus of the invention.

### DETAILED DESCRIPTION

Hereinafter, exemplary embodiments of the invention are described.

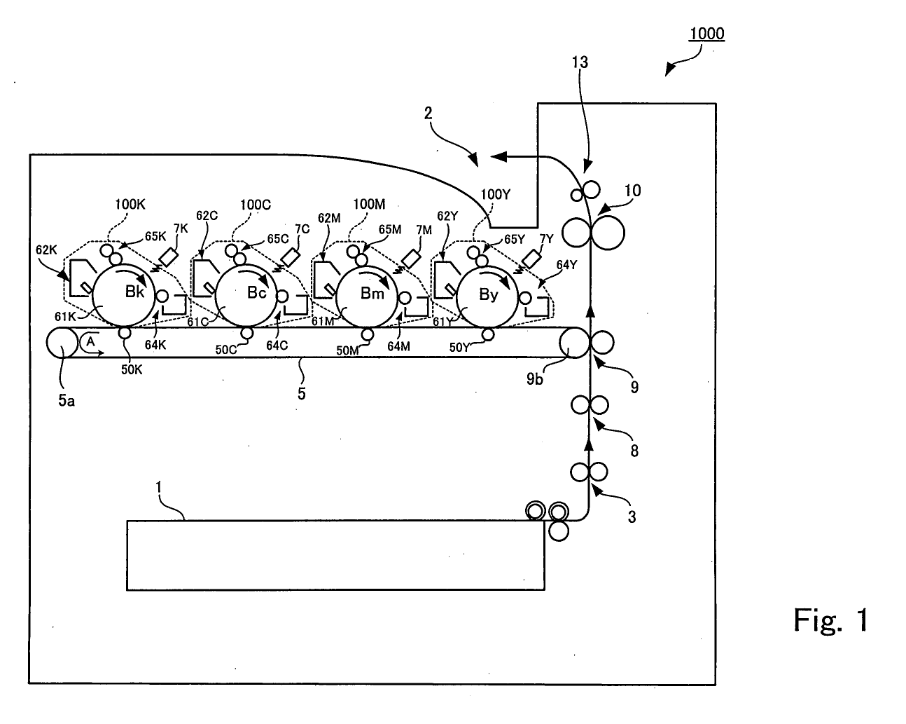

FIG. 1 is the whole block diagram of an image forming apparatus corresponding to one exemplary embodiment of the image forming apparatus of the invention.

An image forming apparatus 1000 shown in FIG. 1 is a single-side output color printer using a tandem system. The image forming apparatus 1000 is provided with electrophotographic laminated image carriers 61K, 61C, 61M and 61Y that rotate in the arrowed directions Bk, Bc, Bm and By in this figure. The respective image carriers are provided therearound with charging devices 65K, 65C, 65M and 65Y that charge the respective image carriers, light exposure sections 7K, 7C, 7M and 7Y that form electrostatic latent images for the respective colors black (K), cyan (C), magenta (M) and yellow (Y) by irradiating the charged image carriers with laser lights, developing devices 64K, 64C, 64M and 64Y that develop the electrostatic latent images on the image carriers with developing agents containing toners of the respective colors to form developed images of the respective colors, and cleaning devices 62K, 62C, 62M and 62Y that clean the respective image carriers. In the image forming apparatus 1000, the charging device 65K, the image carrier 61K, the cleaning device 62K and the developing device 64K are integrated into one body serving as an element of process cartridge 100K, and similarly, the charging device 65C, the image carrier 61C, the cleaning device 62C and the developing device 64C, the charging device 65M, the image carrier 61M, the cleaning device 62M and the developing device 64M, or the charging device 65Y, the image carrier 61Y, the cleaning device 62Y and the developing device 64Y are integrated into one body serving as an element of process cartridge 100C, 100M or 100Y. The four process cartridges are integrated in the image forming apparatus 1000, whereby the respective parts that are the constituent elements of these process cartridges are arranged in the image forming apparatus 1000. These process cartridges 100K, 100C, 100M and 100Y correspond to one exemplary embodiment of the process cartridge of the invention.

The image forming apparatus 1000 is provided with an intermediate transfer belt 5 which upon transfer (primary transfer) of a developed image of each color formed on each image carrier, delivers the primary-transfer image, primary transfer rolls 50K, 50C, 50M and 50Y that perform primary transfer of the developed image of each color to the intermediate transfer belt 5, a pair of secondary transfer rolls 9 that perform secondary transfer onto a paper, a fixing device 10 that fixes the secondary transfer image on the paper, a tray 1 accommodating papers, and four toner cartridges (not shown) that replenish four developing devices with toners of the respective color constituents. The intermediate transfer belt 5 stretched between a secondary transfer roll 9b and a driving roll 5a receives driving force from the driving roll 5a, to circulate and move in the direction of arrow A in the figure.

Then, the work of image formation in the image forming apparatus 1000 is described.

The four image carriers 61K, 61C, 61M, and 61Y are charged respectively by the charging devices 65K, 65C, 65M and 65Y, and receive laser lights emitted from the light exposure sections 7K, 7C, 7M and 7Y to form electrostatic latent images on the respective image carriers. The formed electrostatic latent images are developed with developing agents containing toners of the respective colors by developing devices 64K, 64C, 64M and 64Y, to form developed images. The developed images of the respective colors formed in this manner are sequentially transferred (primary transfer) and superimposed on the intermediate transfer belt 5 in the order of yellow (Y), magenta (M), cyan (C) and black (K) in primary transfer rolls 50K, 50C, 50M and 50Y corresponding to the respective colors, to form a multicolor primary transfer image. Then, this multicolor primary transfer image is delivered with the intermediate transfer belt 5 onto a pair of secondary transfer rolls 9. In concert with formation of the multicolor primary image, a paper is taken out from tray 1, delivered by a delivery roll 3 and adjusted to have a suitable posture by a pair of position adjusting rolls 8. Then, the multicolor primary transfer image is transferred with a pair of secondary transfer rolls 9 onto the delivered paper (secondary transfer), and the secondary transfer image on the paper is subjected to fixing treatment with the fixing device 10. After fixing treatment, the paper having the fixed image thereon is passed through a pair of delivery rolls 13 and output to a copy receiving tray 2.

The forgoing is a description of the work of image formation in the image forming apparatus 1000.

Now, the charging devices 65K, 65C, 65M and 65Y used in the image forming apparatus 1000 are described. The four charging devices have a similar structure, and these charging devices for each color are described collectively as the charging device 65. In the following description, the image carriers charged with the charging device 65, that is, the image carriers 61K, 61C, 61M and 61Y for the respective colors in FIG. 1, are described collectively as the image carrier 61.

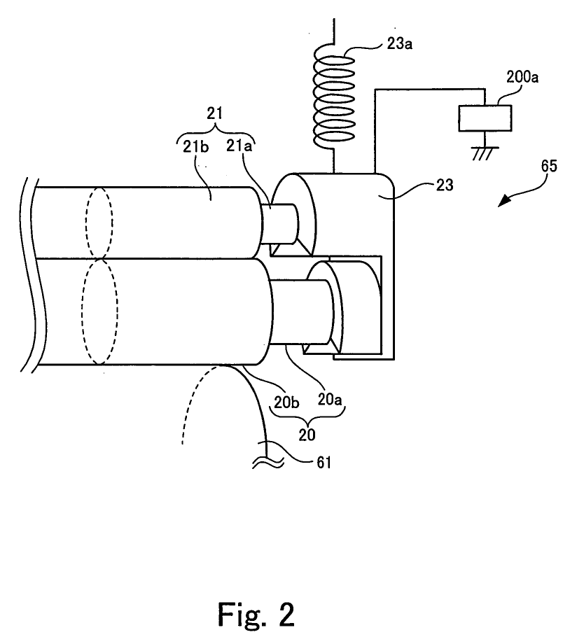

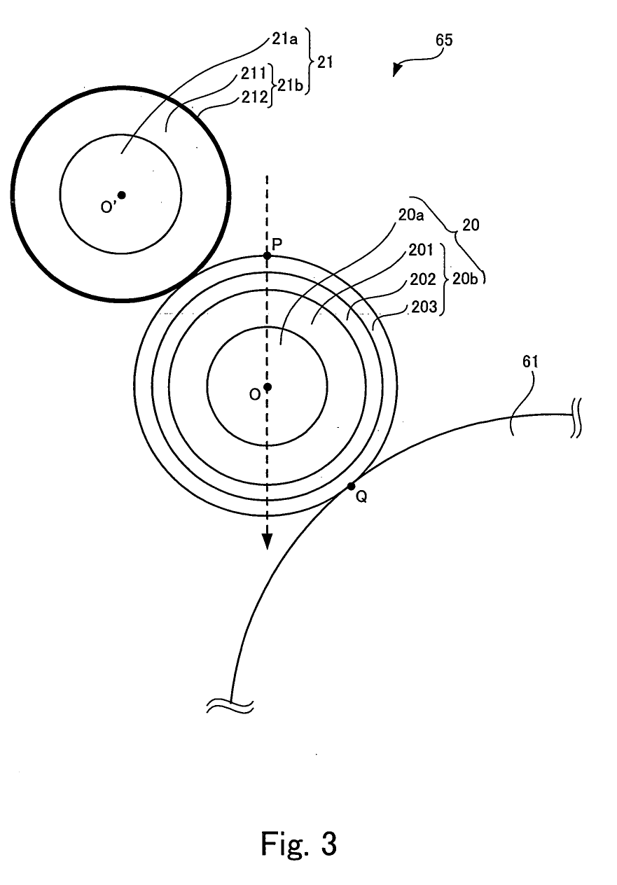

FIG. 2 is an external view of a part of the charging device 65 shown in FIG. 1, and FIG. 3 is a sectional view of the charging device 65 in FIG. 2.

The charging device 65 is provided with a charging member which while being rotated following the movement of the image carrier 61, charges the image carrier 61, and a cleaning member 21 which while being rotated following the movement of the charging member 20, removes a toner and a toner external additive adhering to the surface of the charging member 20. The cleaning member 21 is described as the one being rotated following the movement of the charging member 20, but in the invention, the cleaning member may be rotated at a rotation speed different from the rotation speed of the charging member in the charging device in order to improve the cleaning performance of the cleaning member.

The charging member 20 and the cleaning member 21 are in the form of a thin and long cylinder, and in FIG. 2, one end of this cylinder is shown together with other elements of the charging device 65. The charging device 65 is provided with the charging member 20 and the cleaning member 21 and also with a bearing 23 that supports the charging member 20 and the cleaning member 21 and with a spring 23a that is fixed at the end thereof to the bearing 23 and pushes the bearing 23 against the image carrier 61.

The bearing 23 is formed of an electroconductive material and plays a role in supporting the charging member 20 and the cleaning member 21. The bearing 23 receives high voltage from a charging voltage-applying part 200a, and by application of this high voltage, there arises a difference in potential between the charging member 20 and the image carrier 61, and when the image carrier is rotated in this state, the charging of the image carrier 61 is realized.

The spring 23a pushes the bearing 23 against the image carrier 61 thereby pushing the whole of the charging device 65 against the image carrier 61. By such action of the spring 23a, the charging member 20 is pressure-contacted with the image carrier 61.

The arrangement of the cleaning member 21 relative to the charging member 20 and the image carrier 61 is described. In FIG. 3, the vertical direction is shown by a dotted-line array passing through the center of a section of the charging member 20, and as shown in this figure, this dotted line intersects, at point P above the center O of a section of the charging member 20, with the circumference of a section of the charging member 20. The section of the charging member 20 contacts, at point Q, a section of the image carrier 61. As shown in the figure, the cleaning member 21 is arranged such that a line segment, with which the center O′ of a section of the cleaning member 21 is connected with the center O of a section of the charging member 20 does not intersect with a circular arc continuing in clockwise direction from the pint P to the point Q. By this arrangement, it is possible to prevent a toner or a toner external additive removed from the surface of the charging member 20 by the cleaning member 21 from dropping onto the charging member 20 or onto the image carrier 61.

Now, the cleaning member 21 is described in detail.

The cleaning member 21 has a cylindrical roll shaft 21a serving as a core of the cleaning member 21 and connected to a bearing 23, and a cleaning roll 21b with which the external surface of the cleaning roll shaft 21a except in the vicinity of an area where the cleaning roll shaft 21a is connected to the bearing 23 is covered. FIG. 2 shows the end where the cleaning roll shaft 21a is exposed without being covered with the cleaning roll 21b. The cleaning roll shaft 21a is a rotating member supported with the bearing 23 and integrated with the cleaning roll 21b, and is composed of an electroconductive material. The cleaning roll 21b is pressure-contacted with the charging member 20 and simultaneously rotated following the movement of the charging member 20, thereby cleaning the charging member 20. As shown in FIG. 3, the cleaning roll 21b is composed of both the cleaning roll body 211 composed of a polymer material having a foamed structure and the covering film 212 with which the surface of the cleaning roll body 211 is covered. The polymer material forming the cleaning roll body 211 is a material having a foamed structure by which adhering matter on the surface of the charging member is easily scraped away. Such polymer material includes, for example, resin foams such as urethane foam.

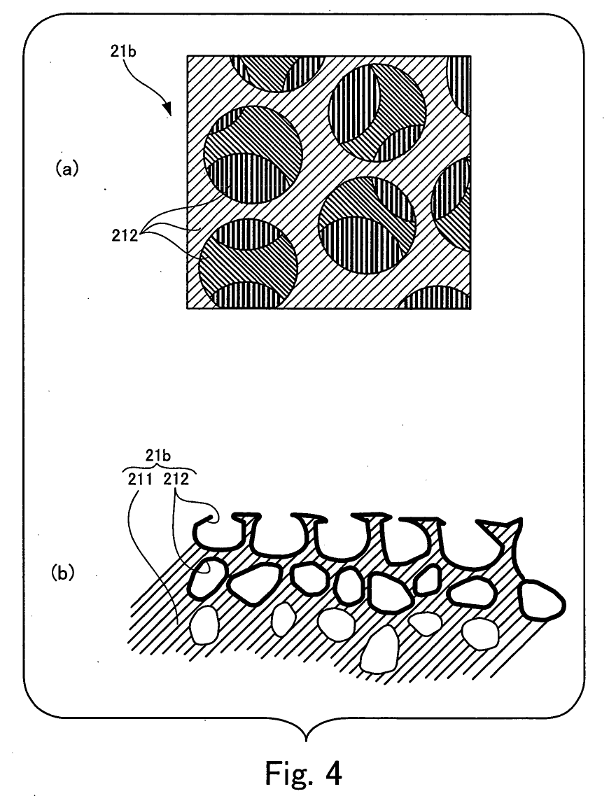

FIG. 4 shows the surface of the cleaning roll.

The part (a) in FIG. 4 shows the appearance of the surface of the cleaning roll 21b when viewed from the outside of the cleaning roll 21b. The part (b) in FIG. 4 shows the appearance in the vicinity of the surface of the cleaning roll 21b. The cleaning roll body 211 is composed of a material having a foamed structure, and thus the surface of the cleaning roll 21b is microscopically uneven with a number of small pores as shown in the part (a) in FIG. 4, and the cleaning roll body 211 is covered with the covering film 212 along the above uneven surface such that the uneven surface is maintained as shown in the part (b) in FIG. 4. Accordingly, performance of the cleaning roll 21b to scrape away adhering matter on the surface of the charging member is not hindered even if the covering film 212 is present. The covering film 212 is constituted such that electroconductive particles are dispersed in the resin material having a crosslinked structure, and by dispersing the electroconductive particles, the surface of the cleaning roll 21b is endowed with electroconductive property.

Generally, when a polymer material having a foamed structure is used as a material of the cleaning roll body, foreign substances such as abrasive powder generated in a process for producing a cleaning member are often incorporated into the cleaning roll body. The cleaning member is always abutted on a rotating charging member, thus easily charging foreign substances by static electricity friction (frictional electrification) generated upon abutting on the rotating charging member, and the charged foreign substances are transferred by electrostatic force from the cleaning member to the surface of the charging member, and adhere to the surface of the charging member thereby sometimes deteriorating the charging performance of the charging member. Accordingly, it can be anticipated that the surface of the cleaning member is covered with an electroconductive particle-containing resin thereby allowing electric charges to flow easily on the surface of the cleaning member to suppress the frictional electrification of foreign substances. However, the surface of the cleaning member, when covered with a usual resin, reduces its elasticity, and thus the whole of the cleaning member is deformed to make it easily bumpy. As a result, the whole of the charging device becomes vibrated and may generate image defects due to vibration.

In the cleaning roll 21b in FIG. 3, a special resin material having a crosslinked structure is used to maintain electroconductive particles on the surface of the cleaning roll 21b, and due to this crosslinked structure, the surface of the cleaning roll 21b has elasticity. By this elasticity, the cleaning roll 21b even when deformed with stress applied along the surface of the cleaning roll 21b will easily return to the original state, thus smoothly cleaning the charging member 20. As a result, excellent image formation is feasible in the image forming apparatus 1000 in FIG. 1 by suppressing image defects caused by the vibration.

In the covering film 212, the degree of crosslinking of the covering film, which represents the weight proportion of a crosslinking component forming the crosslinked structure, is 65% or more. The degree of crosslinking as used herein is specifically a degree determined by the following procedure.

First, a cube of 20 mm×20 mm×20 mm composed exclusively of the cleaning roll body 211 not containing the covering film 212 is cut off from the cleaning roll 21b and then measured for its weight. Then, the surface of the cube is covered with the covering film 212. Then, the weight of the cube after coverage is measured, and from this weight, the weight of the cube before coverage and the weight of the additives such as electroconductive particles used in forming the covering film 212 are subtracted, thereby determining the total weight of the resin in the covering film 212. For arranging the covering film 212, the resin material in the form of a solution is applied and subjected to crosslinking reaction to form a crosslinked structure as described later. Then, the solution is sufficiently dried in a drying oven at 150° C. for 30 minutes and then cooled to room temperature. After this cooling, the measurement of the weight of the cube after coverage as described above is carried out.

Then, the cube covered with the covering film 212 is dipped in an organic solvent acetone and then left overnight. Thereafter, the cube is removed, washed well with a large amount of acetone and then sufficiently dried until no acetone remains therein, and the weight of the cube after drying is measured. When the cube is dipped in acetone, the resin forming a crosslinked structure on the surface of the cube is contacted in a large area with acetone and easily dissolved in acetone. Accordingly, the weight of the crosslinking component forming the crosslinked structure is determined by subtracting the weight of the cube dried after dipping in acetone, from the weight of the cube provided with the covering film 212 before dipping in acetone.

Then, the proportion of the crosslinking component in the resin in the covering film 212 can be determined by dividing the weight of the crosslinking component by the weight of the whole resin in the covering film 212. This proportion expressed in percentage is the degree of crosslinking. That is, the degree of crosslinking is determined by the following equation: Degree of crosslinking=100×(weight of the crosslinking component)/(total weight of the resin in the covering film)

The covering film 212 having a crosslinking degree of 65% or more is a covering film having a considerably developed crosslinked structure, and by providing the cleaning roll 21b with such covering film 212, the charging member 20 is extremely smoothly cleaned. As a result, image defects due to vibration can be effectively suppressed in the image forming apparatus in FIG. 1.

For conferring suitable elasticity on the surface of the cleaning roll 21b, the thickness of the covering film 212 is preferably 0.1 to 100 μm, more preferably 0.1 to 50 μm.

Now, the material forming the covering film 212 is described.

The covering film 212 of the cleaning roll 21b is a layer formed from an electroconductive particle-containing resin by making a crosslinked structure of the resin through chemical reaction with heat, a light or an electron beam, and the resin making a crosslinking structure through the chemical reaction includes resins described in “Kakyozai Handbook” (Crosslinking Agent Handbook) edited by Shinzo Yamashita & Tosuke Kaneko and published by Taiseisha (1981). Specifically, the resin that can be used to form the covering film 212 is one resin or a combination of resins which while satisfying a crosslinking system described in the “Kakyozai Handbook”, are selected from resins such as a polyurethane resin, an epoxy resin, an unsaturated polyester resin, an acrylic resin, a polyamide resin, an isocyanate resin, an amino resin, a melamine resin, an urea resin, a benzoguanamine resin, an acetoguanamine resin, a phenolic resin, a resorcinol resin, a xylene resin, a furan resin, a diallylphthalene resin, a polyamide-imide resin and a nylon resin. Plastic resins such as polyethylene, an ethylene-vinyl acetate copolymer, polyvinyl chloride, polypropylene and unsaturated polyester, and rubber resins such as nitrile rubber, silicone rubber, ethylene propylene rubber, ethylene-vinyl acetate rubber, urethane rubber, fluorine rubber, acrylic rubber, chloroprene rubber, chlorosulfonated rubber, epichlorohydrin rubber, carboxyl rubber, acrylic rubber, butyl rubber and ethylene propylene rubber may also be used.

Among these resins, a resin material having functional groups chemically reacting by heat, a light or an electron beam and constructing a 3-dimensional crosslinked structure by chemical reaction of the functional groups provides the surface of the cleaning roll 21b easily with a crosslinked structure, and the covering film 212 is provided with a 3-dimensional structure constructed by the chemical reaction of such functional groups.

The electroconductive particles contained in the covering film 212 include particles of carbon black such as ketjen black, acetylene black, oil farness black and thermal black and ionic conductive agents using ammonium compounds such as tetraethyl ammonium, stearyltrimethyl ammonium chloride, etc. Particularly, inexpensive and easily available carbon black is preferable, and carbon black is used as the electroconductive particles in the electroconductive particles in the covering film 212. The covering film 212 contains the electroconductive particles in an amount sufficient to confer electrical conductivity on the covering film 212, and the average volume resistivity of the covering film 212 is less than 10¹⁰ Ω·cm. According to JIS K6911 (1995), the volume resistivity can be determined from a current value measured with a microammeter R8340A (manufactured by Advantest Corporation), 5 seconds after application of a voltage of 100 V in an environment of 22° C. and 55% RH with circular electrodes (UR probe of HIRESTER IP manufactured by Mitsubishi Petrochemical Co., Ltd.: the external diameter Φ of the circular electrode, 16 mm; the internal diameter Φ of a ring-shaped electrode section, 30 mm; the external diameter Φ of the ring-shaped electrode section, 40 mm).

The covering film 212 may be compounded with additives such as a flame retardant, a degradation preventing agent and a plasticizer in addition to the electroconductive particles.

As shown in the part (a) in FIG. 4, the average diameter of pores (cell diameter) present on the surface of the cleaning roll 21b, that is, the average diameter of pores on the surface of the cleaning roll body 211, is 100 μm to 1.0 mm. When the cell diameter is less than 100 μm, dirt removed from the charging roll may be accumulated in cells to cause clogging thus deteriorating cleaning performance and causing a problem for image qualities. When the cell diameter is more than 1.0 mm, the surface of the charging roll cannot be uniformly cleaned, and uneven dirt occurs on the surface of the charging roll, resulting sometimes in image defects. The cell diameter refers to the number-average cell diameter determined by measuring the diameters of cells in a length of 25 mm in arbitrary 3 positions in the cleaning member 21 under an optical microscope.

The polymer material of the cleaning roll body 211 includes foams and elastomers such as those of a polyurethane resin, a polypropylene resin, a polystyrene resin, polyethylene, a melamine resin, polyester, polycarbonate, polyamide, polyimide, polyamide-imide, polyarylate, polystyrene, polyvinyl chloride, an acrylonitrile-butadiene-styrene copolymer (ABS), cellulose acetate, epoxy, phenol, isoprene rubber (IR), nitrile rubber (NBR), chloroprene, and an ethylene-propylene-diene terpolymer (EPDM). Foams and elastomers such as those of a nylon resin, a polyethylene terephthalate resin, an ethylene-vinyl acetate copolymer, butyl rubber, nitrile rubber, polyisoprene rubber, polybutadiene rubber, silicone rubber, natural rubber, ethylene-propylene rubber, ethylene-propylene-diene rubber, styrene-butadiene rubber, acrylic rubber, and chloroprene rubber may also be used. Among these materials, a foam (urethane foam) of polyurethane resin is particularly preferable. The foam can be obtained by using a polyol as a main component, a foam stabilizer and a catalyst. For example, the urethane foam can be obtained by mixing a polyurethane polyol with a foam stabilizer etc. and then curing and foaming the mixture by heating, wherein the mixing temperature is usually in the range of 10° C. to 90° C., preferably 20° C. to 60° C., and the mixing time is usually 10 seconds to 20 minutes, preferably 30 seconds to 5 minutes. As the foaming method, a method of using a foaming agent or a method of mixing bubbles by mechanical stirring may be used.

In addition to the polyurethane polyol, polyoxypropylene glycol, polyoxytetramethylene glycol, polyester polyol, polycaprolactone polyol, polycarbonate polyol etc. corresponding to the type of the above foam may be used as the polyol. These polyols may be used alone or as a mixture of two or more thereof.

The foam stabilizer used herein includes a silicone-based surfactant such as dimethyl silicone oil and polyether-modified silicone oil, a cationic surfactant, an anionic surfactant and an amphoteric surfactant.

The catalyst includes, for example, amine-based catalysts such as triethylamine, tetramethylethylene diamine, triethylene diamine (TEDA), bis(N,N-dimethylamino-2-ethyl)ether, N,N,N′,N′-tetramethylhexamethylene diamine, bis(2-dimethylaminoethyl)ether (trade name: TOYOCAT-ET, manufactured by Tosoh Corporation), metal carboxylate such as potassium acetate and potassium octylate, and organometallic compounds such as dilaurate dibutyltin. When urethane foam is used as the polymer material of the cleaning roll body 211, the amine-based catalysts are preferable because they are suitable for production of water-foaming polyurethane foam. The above reaction catalysts may be used alone or as a mixture of two or more thereof. The amount of the catalyst used is preferably 0.01% to 5% by weight or less, more preferably 0.05% to 3% by weight, even more preferably 0.1% to 1% by weight, relative to the amount of the polyol (or the total amount of the polyol and an isocyanate described later when the isocyanate is added) If the catalyst is not used, an unreacted polymer may remain in the cleaning roll and exude to the area of contact with the charging member, and thus the catalyst is preferably used. The polymer material of the cleaning roll body 211 may be compounded with additives such as a flame retardant, a degradation preventing agent and a plasticizer. If necessary, electroconductive particles may be added thereto.

An isocyanate may be used as a crosslinking agent for crosslinking with a polyol. The isocyanate that can be used includes tolylene diisocyanate(TDI), diphenylmethane diisocyanate, naphthalene diisocyanate, toluidine diisocyanate, isophorone diisocyanate, hexamethylene diisocyanate, xylylene diisocyanate, hydrogenated xylylene diisocyanate, hydrogenated diphenylmethane diisocyanate, triisocyanate, tetramethylxyylene diisocyanate, lysine ester tosyisocyanate, lysine diisocyanate, trimethylhexamethylene diisocyanate, dimer acid diisocyanate, and norbornene diisocyanate. These isocyanates may be used alone or as a mixture of two or more thereof.

The material of the cleaning roll shaft 21a should be an electroconductive material and is preferably an electroconductive metal such as iron, copper, brass, stainless steel, aluminum and nickel, and a material endowed with conductive property by dispersing electroconductive particles in a resin base may also be used.

The cleaning roll 21b is a cleaning roll composed of both the cleaning roll body 211 made of a polymer material having a foamed structure and a covering film 212, but in the cleaning member of the invention, an intermediate layer for improving adhesiveness to the cleaning roll shaft 21a may be arranged between the cleaning roll body 211 and the cleaning roll shaft 21a.

The method for manufacturing the cleaning roll 21b includes a method that involves injecting a raw material into a mold, foaming it to form urethane foam of desired shape and then coating a core material with the urethane foam, a method that involves molding urethane foam into a slab which is then processed by cutting or the like into a desired shape followed by coating a core material with the urethane foam.

Then, the charging member 20 shown in FIGS. 2 and 3 is described in detail.

The charging member 20 is composed of both a cylindrical shaft 20a serving as a core of the cleaning member 20 and connected to a bearing 23 and a charging roll 20b with which the periphery of the shaft 20a except in the vicinity of both ends of the cylinder of the shaft 20a is covered as shown in FIG. 2. FIG. 2 also shows the end where the shaft 20a is exposed without being covered with the charging roll 20b. The shaft 20a is an electroconductive member supported by the bearing 23 and integrated with the charging roll 20b, and is rotated following the movement of the rotation of the image carrier 61 in FIG. 1. As shown in FIG. 3, the charging roll 20b is composed of three layers that are an elastic layer 201, a resistance layer 202 and a surface layer 203, and these 3 layers are layered in the order of the elastic layer 201, the resistance layer 202 and the surface layer 203 outside of the external surface of the shaft 20a. The elastic layer 201 is a layer consisting of an elastic polymer material mixed with electroconductive particles, and the resistance layer 202 is a layer for regulating the resistance of the charging roll 20b and is composed of an electroconductive polymer material mixed with electroconductive particles. The surface layer 203 is a layer for protecting the resistance layer 202.

The material of the shaft 20a should be an electroconductive material and is preferably an electroconductive metal such as iron, copper, brass, stainless steel, aluminum and nickel, and a material endowed with conductive property by dispersing electroconductive particles in a resin base may also be used.

A rubber material having electroconductive particles or semiconductive particles dispersed therein is used as the material of the elastic layer 201. The rubber material that can be used includes EPDM, polybutadiene, natural rubber, polyisobutylene, SBR, CR, NBR, silicone rubber, urethane rubber, epichlorohydrin rubber, SBS, thermoplastic elastomer, norbornen rubber, fluorosilicone rubber and ethylene oxide rubber. The electroconductive particles or semiconductive particles that can be used include particles of carbon black, metals such as zinc, aluminium copper, iron, nickel, chromium and titanium; and particles of metal oxides such as ZnO—Al₂O₃, SnO₂—Sb₂O₃, In₂O₃—SnO₂, ZnO—TiO₂, MgO—Al₂O₃, FeO—TiO₂, TiO₂, SnO₂, Sb₂O₃, In₂O₃, ZnO and MgO. These materials may be used alone or as a mixture of two or more thereof.

As the material of the resistance layer 202, a binder resin having electroconductive particles or semiconductive particles dispersed therein is used. Examples of the binder resin used in the resistance layer 202 include an acrylic resin, a cellulose resin, a polyamide resin, methoxymethylated nylon, an ethoxymethylated nylon, a polyurethane resin, a polycarbonate resin, a polyester resin, a polyethylene resin, a polyvinyl resin, a polyarylate resin, a polythiophene resin, polyolefin resins such as PFA, FEP and PET, and a styrene butadiene resin. The electroconductive particles or semiconductive particles used in the resistance layer 202 include the same as the electroconductive particles or semiconductive particles used in the elastic layer 201. If necessary, an antioxidant such as hindered phenol and hindered amine, a filler such as clay and kaolin, a lubricant such as silicone oil or the like may be added. The amount of the electroconductive particles or semiconductor particles used in the resistance layer 202 should be regulated such that the specific resistance (volume resistivity) of the resistance layer 202 is 10³ Ωcm to 10¹⁴ Ωcm, and the specific resistance (volume resistivity) is preferably from 10⁵ Ωcm to 10¹² Ωcm, most preferably from 10⁷ Ωcm to 10¹² Ωcm.

The material of the surface layer 203 is not particularly limited as long as it is an electroconductive resin layer, and a resin layer that is almost the same as the material of the resistance layer 202 can be used. The total thickness of the surface layer 203 and the resistance layer 202 may be 0.01 μm to 1000 μm, preferably 0.1 μm to 500 μm, more preferably 0.5 μm to 100 μm. The surface layer may be arranged if necessary, and a charging roll having no surface layer on the resistance layer 202 may be used in the image forming apparatus 1000 shown in FIG. 1.

The voltage applied from a charging voltage-applying part 200a via bearing 23 to the charging member 20 may be a voltage having an AC component overlapping with a DC component or a voltage having exclusively a DC component, and is particularly preferably a voltage consisting exclusively of a DC component. The voltage (absolute value) is preferably 50 V to 2000 V, most preferably 100 V to 1500 V. When AC voltage overlaps, the magnitude of the voltage may be 200 V to 900 V, preferably 400 V to 800 V. most preferably 600 V to 800 V. The frequency of the AC voltage may be 50 Hz to 20 kHz, more preferably 100 Hz to 5 kHz.

Now, the image carrier shown in FIG. 1 is described. As described above, the four image carriers 61K, 61C, 61M and 61Y in FIG. 1 have a similar structure, and these image carriers for each color are described collectively as the image carrier 61.

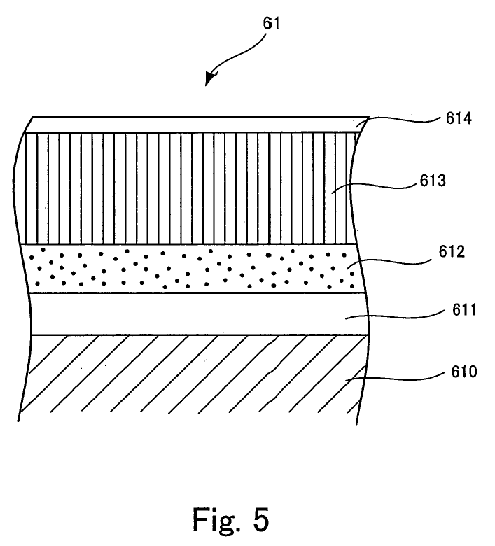

FIG. 5 is a schematic sectional view representing the layer structure of the image carrier shown in FIG. 1.

The image carrier shown in FIG. 1 is formed by layering, on an electroconductive base 610, an undercoat layer 611 which prevents a light incident on the image carrier from being reflected on the surface of the base 610, a charge-generating layer 612 which upon receiving laser lights from image exposure devices 114K, 114C, 114M and 114Y shown in FIG. 1, generates a carrier having an electric charge, a charge-transporting layer 613 on which a carrier is transported, and a protective layer 614 which serves as the outermost layer of the image carrier 61 and protects the image carrier 61, in this order.

As the material of the base 610, metals such as aluminum, nickel, chromium and stainless steel may be used. A plastic film onto which a metal film made of such metal or gold, vanadium, tin oxide, indium oxide or ITO is attached may also be used. A paper, plastic film or the like having an electroconductivity-conferring agent applied thereto or impregnated therein may also be used as the material of the base 610.

Preferably, the surface of the base 610 is roughened to have a centerline average roughness (Ra) of from 0.04 μm to 0.5 μm for preventing interference fringes that may occur due to laser light irradiated by the light exposure portions 7K, 7C, 7M and 7Y in FIG. 1. If the surface centerline average roughness (Ra) of the base 610 is less than 0.04 μm, then it is n ear to a mirror face condition and its interference-preventing effect will be insufficient. On the other hand, if the surface centerline average roughness (Ra) is more than 0.5 μm, then even though a film is formed thereon, the image quality may be poor. When non-interference light is used as a light source, the surface-roughening treatment for interference fringe prevention is not always necessary and defects to be caused by the surface roughness of the base 610 may be prevented. Accordingly, this is suitable for life prolongation. For roughening the surface of the support, it is preferable to use, for example, a wet-honing method of jetting an abrasive suspension in water to a support or a centerless grinding method of pressing a support against a rotating grindstone for continuously grinding it, or a method of anodic oxidation. A different mode of surface roughening may also be employed herein. This is as follows: The surface of the base 610 is not directly roughened. A dispersion of a conductive or semiconductive powder in a resin is applied to it so as to from a layer on the surface of the support. The fine particles in the layer may roughen the surface of the thus-covered support. This is also preferably employed herein. The anodic oxidation comprises processing the aluminium surface of a support in an electrolytic solution in which the aluminium acts as an anode for anodic oxidation to form an oxide film on the aluminium surface. The electrolytic solution includes sulfuric acid solution and oxalic acid solution. However, the porous oxide film, if not further processed after anodic oxidation, is chemically active and is readily polluted, and in addition, its environment-dependent resistance fluctuation is great. Accordingly, the oxide film formed through anodic oxidation is further processed for hydration with pressure steam or in boiling water (optionally a metal salt of nickel or the like may be added to it) to attain volume expansion for sealing up the fine pores of the film, whereby the oxide film is converted into a more stable hydrate oxide film. Preferably, the thickness of the oxide film in anodic oxidation is from 0.3 to 15 μm. If it is less than 0.3 μm, then the barrier property of the film against injection is poor and its effect may be unsatisfactory. On the other hand, if it is more than 15 μm, then it may cause residual potential increase in repeated use.

The base 610 may be processed with an aqueous acid solution or may be subjected to boehmite processing. The processing with an acid solution comprising phosphoric acid, chromic acid and hydrofluoric acid may be effected as follows: First, the acid solution is prepared. The blend ratio of phosphoric acid, chromic acid and hydrofluoric acid to form the acid solution is preferably as follows: Phosphoric acid is from 10 to 11% by weight, chromic acid is from 3 to 5% by weight, and hydrofluoric acid is from 0.5 to 2% by weight. The overall acid concentration of these is preferably from 13.5 to 18% by weight. The processing temperature is preferably from 42 to 48° C. At a higher temperature, a thicker film may be formed more rapidly. Preferably, the thickness of the film is from 0.3 to 15 μm. If it is less than 0.3 μm, then its barrier property against injection is poor and its effect may be insufficient. On the other hand, if it is more than 15 μm, then it may cause residual potential increase in repeated use. The boehmite processing may be attained by dipping the support in pure water at 90° C. to 100° C. for 5 to 60 minutes, or by contacting the support with heated steam at 90° C. to 120° C. for 5 to 60 minutes. Preferably, the thickness of the film is from 0.1 to 5 μm. This may be further processed for anodic oxidation with an electrolytic solution of low film dissolution ability, such as a solution of adipic acid, boric acid, borate, phosphate, phthalate, maleate, benzoate, tartrate or citrate.

Now, the undercoat layer 611 in FIG. 5 is described in detail. The undercoat layer 611 is a layer containing, for example, an organometallic compound and a binder resin. The undercoat layer 611 may be arranged if necessary, and an image carrier without the undercoat layer 611 may be used in the process cartridge and the image forming apparatus of the invention.

The organometallic compound contained in the undercoat layer 611 includes organozirconium compounds such as zirconium chelate compounds, zirconium alkoxide compounds, zirconium coupling agents; organotitanium compounds such as titanium chelate compounds, titanium alkoxide compounds, and titanium coupling agents; organoaluminium compounds such as aluminium chelate compounds, and aluminium coupling agents; as well as antimony alkoxide compounds, germanium alkoxide compounds, indium alkoxide compounds, indium chelate compounds., manganese alkoxide compounds, manganese chelate compounds, tin alkoxide compounds, tin chelate compounds, aluminium silicon alkoxide compounds, aluminium titanium alkoxide compounds, and aluminium zirconium alkoxide compounds. As the organometallic compound, organozirconium compounds, organotitanium compounds and organoaluminium compounds are especially preferred since their residual potential is low and they show good electrophotographic properties.

The binder resin may be any known one, including, for example, polyvinyl alcohol, polyvinyl methyl ether, poly-N-vinylimidazole, polyethylene oxide, ethyl cellulose, methyl cellulose, ethylene-acrylic acid copolymer, polyamide, polyimide, casein, gelatin, polyethylene, polyester, phenolic resin, vinyl chloride-vinyl acetate copolymer, epoxy resin, polyvinylpyrrolidone, polyvinylpyridine, polyurethane, polyglutamic acid, and polyacrylic acid. When two or more of these are combined for use herein, their blend ratio may be suitably determined.

The undercoat layer 611 may contain a silane-coupling agent such as vinyltrichlorosilane, vinyltrimethoxysilane, vinyltriethoxysilane, vinyl-tris-2-methoxyethoxysilane, vinyltriacetoxysilane, γ-glycidoxypropyltrimethoxysilane, γ-methacryloxypropyltrimethoxysilane, γ-aminopropyltriethoxysilane, γ-chloropropyltrimethoxysilane, γ-2-aminoethylaminopropyltrimethoxysilane, γ-mercaptopropyltrimethoxysilane, γ-ureidopropyltriethoxysilane, and β-3,4-epoxycyclohexyltrimethoxysilane.

For residual potential reduction and for environmental stability, an electron transport pigment may be mixed/dispersed in the undercoat layer 611. The electron transport pigment includes organic pigments such as perylene pigments, bisbenzimidazoleperylene pigments, polycyclic quinone pigments, indigo pigments and quinacridone pigments described in JP-A No. 47-30330; other organic pigments such as bisazo pigments and phthalocyanine pigments that have an electron-attracting substituent such as a cyano group, a nitro group, a nitroso group or a halogen atom; and inorganic pigments such as zinc oxide and titanium oxide. Of those, preferred for use herein are perylene pigments, bisbenzimidazoleperylene pigments, polycyclic quinone pigments, zinc oxide and titanium oxide, as their electron mobility is high. The pigment surface may be processed with a coupling agent or a binder resin such as those mentioned hereinabove for the purpose of controlling the dispersibility and the charge-transporting ability of the pigment. If too much, the electron transport pigment may lower the strength of the undercoat layer 611 and may cause film defects. Therefore, the content of the pigment is preferably at most 95% by weight, more preferably at most 90% by weight based on the total solid content of the undercoat layer 611. Preferably, various organic compound powder or inorganic compound powder is added to the undercoat layer 611 for the purpose of improving the electric properties and the light-scatterability of the layer. In particular, inorganic pigments, for example, white pigments such as titanium oxide, zinc oxide, zinc flower, zinc sulfide, lead white or lithopone, or body pigments such as alumina, calcium carbonate or barium sulfate, as well as polytetrafluoroethylene resin particles, benzoguanamine resin particles and styrene particles are effective. Preferably, the volume-average particle size of the additive powder is from 0.01 to 2 μm. The additive powder is optionally added to the layer, if desired. Its amount is preferably from 10 to 90% by weight, more preferably from 30 to 80% by weight, based on the total solid content of the undercoat layer 611.

The undercoat layer 611 is formed by coating the base 610 with an undercoat layer-forming coating liquid that contains the above-mentioned constitutive materials. The organic solvent to be used for the undercoat layer-forming coating liquid may be any one that can dissolve the organometallic compound and the binder resin and does not cause gelation or aggregation when an electron transport pigment is mixed and/or dispersed in the liquid. The organic solvent may be any ordinary one, including, for example, methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene and toluene. One or more of these may be used herein either singly or as combined. For mixing and/or dispersing the constitutive materials, any ordinary method may be employed, using, for example, a ball mill, a roll mill, a sand mill, an attritor, a shaking ball mill, a colloid mill or an ultrasonic paint shaker. Mixing and/or dispersing them may be effected in an organic solvent. The coating method for forming the undercoat layer 611 may be any ordinary one, including, for example, a blade coating method, a wire bar coating method, a spraying method, a dipping method, a bead coating method, an air knife coating method, a curtain coating method. Drying the layer may be effected at a temperature at which the solvent may be evaporated away to form a film. In particular, the base 610 processed with an acid solution or processed for boehmite treatment may have an insufficient ability to cover the defects of the base material, and it is thus desirable that the undercoat layer 611 is formed thereon. Preferably, the thickness of the undercoat layer 611 is from 0.01 μm to 30 μm, more preferably from 0.05 μm to 25 μm.

Now, the charge-generating layer 612 is described.

The charge-generating layer 612 is a layer containing a charge-generating material and optionally a binder resin.

The charge-generating material may be any known one, including, for example, organic pigments, e.g., azo pigments such as bisazo pigments, trisazo pigments, condensed cyclic aromatic pigments such as dibromoanthanthrone pigments, as well as perylene pigments, pyrrolopyrole pigments and phthalocyanine pigments, and inorganic pigments such as trigonal system selenium and zinc oxide. In particular, when a laser light having a wavelength of from 380 to 500 nm is used, the charge-generating material is preferably any of metal or non-metal phthalocyanine pigments, trigonal system selenium, or dibromoanthanthrone. Above all, more preferred are hydroxygallium phthalocyanine disclosed in JP-A No. 5-263007 and JP-A No. 5-279591; chlorogallium phthalocyanine disclosed in JP-A No. 5-98181; dichlorotin phthalocyanine disclosed in JP-A No. 5-140472 and JP-A No. 5-140473; and titanyl phthalocyanine disclosed in JP-A No. 4-189873 and JP-A No. 5-43813. The hydroxygallium phthalocyanine pigment is particularly preferably the one having a maximum absorption within the range of from 810 nm to 839 nm in optical absorption spectrum, an volume average particle diameter of 0.10 μm or less, and a BET specific surface area of 45 m²/g or more.

The binder resin may be selected from a wide variety of insulating resins, and may be also selected from organic photoconductive polymers such as poly-N-vinylcarbazole, polyvinylanthracene, polyvinylpyrene and polysilane. Preferred examples of the binder resin include, but are not limited to, insulating resins such as a polyvinyl butyral resin, a polyarylate resin (for example, a polycondensate of bisphenol A and phthalic acid, etc.), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin and a polyvinylpyrrolidone resin. These binder resins may be used solely or as a mixture of plural kinds thereof.

The charge-generating layer 612 may be formed by vapor deposition with a charge-generating material or by coating with a charge-generating layer-forming coating liquid that contains a charge-generating material and a binder resin. When the charge-generating layer 612 is formed by using such a charge-generating layer-forming coating liquid, then the blend ratio (by weight) of the charge-generating material to the binder resin is preferably from 10/1 to 1/10. The constitutive materials may be dispersed in the charge-generating layer-forming coating liquid by using any ordinary method such as a ball mill dispersion method, an attritor dispersion method, or a sand mill dispersion method. In this method, it is indispensable that the crystal form of the pigment does not change through the dispersion treatment. Preferably, the dispersed particles have a particle size of 0.5 μm or less, more preferably 0.3 μm or less, even more preferably 0.15 μm or less. Any ordinary organic solvent may be used for the dispersion, including, for example, methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene and toluene. These solvents may be used alone or as a mixture of two or more thereof. For forming the charge-generating layer 612 by the use of such a charge-generating layer-forming coating liquid, any ordinary coating method may be employed, including, for example, a blade coating method, a wire bar coating method, a spraying method, a dipping method, a bead coating method, an air knife coating method and a curtain coating method.

Preferably, the thickness of the charge-generating layer 612 is from 0.1 μm to 5 μm, more preferably from 0.2 to 2.0 μm.

Now, the charge-transporting layer 613 is described.

The charge-transporting layer 613 is a layer containing a charge-transporting material, a binder resin and a charge-transporting polymer material. The charge-transporting material includes, but is not limited to, electron-transporting compounds such as quinone compounds, e.g., p-benzoquinone, chloranil, bromanil and anthraquinone, tetracyanoquinodimethane compounds, fluorenone compounds e.g., 2,4,7-trinitrofluorenone, xanthone compounds, benzophenone compounds, cyanovinyl compounds and ethylene compounds; and hole-transporting compounds such as triarylamine compounds, benzidine compounds, arylalkane compounds, aryl-substituted ethylene compounds, stilbene compounds, anthracene compounds and hydrazone compounds. These charge-transporting materials may be used singly or as a mixture of two or more thereof. In view of its mobility, the charge-transporting material is preferably a compound of the following formula (I), (II) or (III):

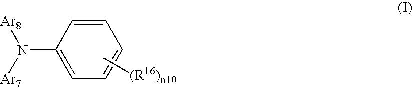

wherein R¹⁶ represents a hydrogen atom or a methyl group; n10 indicates 1 or 2; Ar₆ and Ar₇ each independently represent a substituted or unsubstituted aryl group, —C₆H₄—C(R³⁸)═C(R³⁹ )(R⁴⁰) or —C₆H₄—CH═CH—CH═C(Ar)₂, and the substituent for these is a halogen atom, an alkyl group having 1 to 5 carbon atoms, an alkoxy group having 1 to 5 carbon atoms, or a substituted amino group substituted with an alkyl group having from 1 to 3 carbon atoms; R³⁸, R³⁹ and R⁴⁰ each independently represent a hydrogen atom, a substituted or unsubstituted alkyl group, or a substituted or unsubstituted aryl group; and Ar represents a substituted or unsubstituted aryl group.

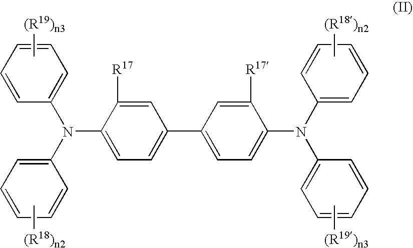

wherein R¹⁷ and R¹⁷′ each independently represent a hydrogen atom, a halogen atom, an alkyl group having 1 to 5 carbon atoms, or an alkoxy group having 1 to 5 carbon atoms; R¹⁸, R¹⁸′, R¹⁹ and R¹⁹′ each independently represent a halogen atom, an alkyl group having 1 to 5 carbon atoms, an alkoxy group having 1 to 5 carbon atoms, an amino group substituted with an alkyl group having 1 or 2 carbon atoms, a substituted or unsubstituted aryl group, —C(R³⁸)═C(R³⁹)(R⁴⁰) or —CH═CH—CH═C(Ar)₂; R³⁸, R³⁹ and R⁴⁰ each independently represent a hydrogen atom, a substituted or unsubstituted alkyl group, or a substituted or unsubstituted aryl group; Ar represents a substituted or unsubstituted aryl group; and n2 and n3 each independently indicate an integer of from 0 to 2.

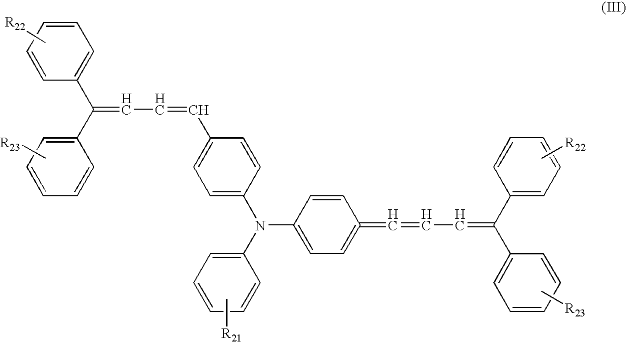

wherein R₂₁ represents a hydrogen atom, an alkyl group having 1 to 5 carbon atoms, an alkoxy group having 1 to 5 carbon atoms, a substituted or unsubstituted aryl group, or —CH═CH—CH═C(Ar)₂; Ar represents a substituted or unsubstituted aryl group; R₂₂ and R₂₃ each independently represent a hydrogen atom, a halogen atom, an alkyl group having 1 to 5 carbon atoms, an alkoxy group having 1 to 5 carbon atoms, an amino group substituted with an alkyl group having 1 or 2 carbon atons, or a substituted or unsubstituted aryl group.

The binder resin for use in the charge-transporting layer 613 includes a polycarbonate resin, a polyester resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone-alkyd resin, a phenol-formaldehyde resin and a styrene-alkyd resin. These binder resins may be used alone or as a mixture of two or more thereof. Preferably, the blend ratio (by weight) of the charge-transporting material to the binder resin is from 10/1 to 1/5.

The charge-transporting polymer material may be any known one having an ability to transport an electric carrier, such as poly-N-vinylcarbazole and polysilane. In particular, polyester-based charge-transporting polymer materials disclosed in JP-A No. 8-176293 and JP-A No. 8-208820 are particularly preferably used because they have a high ability to transport an electric carrier.

The charge-transporting layer 613 may be formed by using the charge-transporting layer-forming coating liquid that contains the above-mentioned constitutive material. The solvent for the charge-transporting layer-forming coating liquid may be any ordinary organic solvent, including, for example, aromatic hydrocarbons such as benzene, toluene, xylene and chlorobenzene; ketones such as acetone and 2-butanone; halogenated aliphatic hydrocarbons such as methylene chloride, chloroform and ethylene chloride; and cyclic or linear ethers such as tetrahydrofuran and ethyl ether. These solvents may be used alone or as a mixture of two or more thereof. The charge-transporting layer-forming coating liquid may be applied by any ordinary method such as a blade coating method, a wire bar coating method, a spraying method, a dipping method, a bead coating method, an air knife coating method or a curtain coating method. Preferably, the thickness of the charge-transporting layer 613 is from 5 μm to 50 μm, more preferably from 10 μm to 30 μm.

Now, the protective layer 614 is described. The protective layer 614 is a layer composed of a resin. The protective layer 614 may be arranged if necessary, and an image carrier without the protective layer 614 may be used in the process cartridge and the image forming apparatus of the invention.

The resin forming the protective layer 614 includes charge-transporting polymer materials such as a polycarbonate resin, a polyester resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone-alkyd resin, a phenol-formaldehyde resin, a styrene-alkyd resin, poly-N-vinylcarbazole and polysilane, as well as polyester-based charge-transporting polymer materials disclosed in JP-A No. 8-176293 and JP-A No. 8-208820. Among those mentioned above, thermosetting resins such as a phenolic resin, a thermosetting acrylic resin, a thermosetting silicone resin, an epoxy resin, a melamine resin, a benzoguanamine resin, an urethane resin, a polyimide resin and a polybenzimidazole resin are preferable. Particularly a phenolic resin, a melamine resin, a benzoguanamine resin, a siloxane resin and a urethane resin are preferable, and the protective layer 614 composed of these resins is formed by coating with a coating liquid based on these resins or precursors thereof, and this applied coating liquid is cured by heating treatment simultaneously with drying after coating.

The phenolic resin that can be used to form the protective layer 614 include a monomer such as a monomethylolphenol compound, a dimethylolphenol compound and a trimethylolphenol compound, a mixture thereof, an oligomer thereof, and a mixture of the monomer and the oligomer. Such phenolic resin is obtained specifically by reacting a compound having a phenol structure, such as resorcin and bisphenol, a substituted phenol compound having one hydroxyl group, such as phenol, cresol, xylenol, p-alkylphenol and p-phenylphenol, a substituted phenol having two hydroxyl groups, such as catechol, resorcinol and hydroquinone, a bisphenol compound, such as bisphenol A and bisphenol Z, and a biphenol compound, with formaldehyde, paraformaldehyde or the like in the presence of an acidic catalyst or an alkaline catalyst. As the phenolic resin, compounds that are commercially available as a phenolic resin may be generally used. The phenolic resin is preferably a resol-type phenolic resin. The term “oligomer” herein means a molecule having a relatively large number of repeating units of about from 2 to 20, and a molecule having a molecular weight smaller than the oligomer is referred to as “monomer” herein. The acidic catalyst that can be used includes sulfuric acid, p-toluenesulfonic acid and phosphoric acid. The alkaline catalyst that can be used includes a hydroxide of an alkali metal or an alkaline earth metal, such as NaOH, KOH, Ca(OH)₂ and Ba(OH)₂, and an amine catalyst. The amine catalyst includes, but is not limited to, ammonia, hexamethylenetetramine, trimethylamine, triethylamine and triethanolamine. In the case where a basic catalyst is used, there is such a tendency that carriers are considerably trapped with the catalyst remaining to deteriorate the electrophotographic characteristics. Accordingly, it is preferred that the basic catalyst is deactivated or removed by neutralizing with an acid, or by contacting it with an absorbent, such as silica gel, or an ion exchange resin.

The melamine resins and benzoguanamine resins that can be used to form the protective layer 614 include various resins such as methylol-type resins where free methylol groups remain as they are, full-ether-type resins where methylol groups are all alkyletherified, full-imino-type resins, and mixed-type resins having both methylol and imino groups. Among these resins, ether-type resins are preferable in view of the stability of coating liquids.

The urethane resins that can be used to form the protective layer 614 include polyfunctional isocyanates or isocyanurates, as well as blocked isocyanates prepared by blocking them with alcohols or ketones. Among these materials, blocked isocyanates or isocyanurates are preferable in view of the stability of coating liquids, and these are preferably thermally crosslinked with the additive for the electrophotographic image carrier of the invention.

As the thermosetting silicone resin forming the protective layer 614, a resin derived from a compound represented by the formula (IV) below may be used.

The above-described resins serving as the material forming the protective layer 614 may be used alone or as a mixture of two or more thereof.

Electroconductive particles or charge-transporting materials may be added to the protective layer 614 for reducing the residual potential of the layer. The electroconductive particles include particles of metals, metal oxides, and carbon black. Of those, preferred are metals and metal oxides. The metals include aluminium, zinc, copper, chromium, nickel, silver and stainless steel, or plastic particles covered with such metal through vapor deposition. The metal oxides include zinc oxide, titanium oxide, tin oxide, antimony oxide, indium oxide, bismuth oxide, tin-doped indium oxide, antimony- or tantalum-doped tin oxide, and antimony-doped zirconium oxide. One or more of these may be used singly or as combined. When two or more of them are combined, they may be merely mixed or may be formed into a solid solution or a fused melt. Preferably, the mean particle size of the electroconductive particles is at most 0.3 μm, more preferably at most 0.1 μm, in view of the transparency of the protective layer 614.

A compound represented by the following formula (IV) may be added to the resin forming the protective layer 614 for controlling various physical properties such as strength and film resistance of the protective layer 614.

Si(R⁵⁰)_{(4-c)}Qc (IV)

wherein R⁵⁰ represents a hydrogen atom, an alkyl group or a substituted or unsubstituted aryl groupz; Q represents a hydrolysable group, and c represents an integer of 1 to 4. Specific examples of the compound represented by the formula (IV) include the following silane coupling agents. Examples of the silane coupling agent include a tetrafunctional alkoxysilane (c=4) such as tetramethoxysilane and tetraethoxysilane; a trifunctional alkoxysilane (c=3) such as methyltrimethoxysilane, methyltriethoxysilane, ethyltrimethoxysilane, methyltrimethoxyethoxysilane, vinyltrimethoxysilane, vinyltriethoxysilane, phenyltrimethoxysilane, γ-glycidoxypropylmethyldiethoxysilane, γ-glycidoxypropyltrimethoxysilane, γ-glycidoxypropyltrimethoxysilane, γ-aminopropyltriethoxysilane, γ-aminopropyltrimethoxysilane, γ-aminopropylmethyldimethoxysilane, N-β-(aminoethyl)-γ-aminopropyltriethoxysilane, (tridecafluoro-1,1,2,2-tetrahydrooctyl)triethoxysilane, (3,3,3-trifluoropropyl)trimethoxysilane, 3-(heptafluoroisopropoxy)propyltriethoxysilane, 1H,1H,2H,2H-perfluoroalkyltriethoxysilane, 1H,1H,2H,2H-perfluorodecyltriethoxysilane and 1H,1H,2H,2H-perfluorooctyltriethoxysilane; a difunctional alkoxysilane (c=2), such as dimethyldimethoxysilane, diphenyldimethoxysilane and methylphenyldimethoxysilane; and a monofunctional alkoxysilane (c=1), such as trimethylmethoxysilane. Trifunctional and tetrafunctional alkoxysilanes are preferred for improving the strength of the protective layer 614 as a film, and monofunctional and difunctional alkoxysilanes are preferred for improving the flexibility and the film forming property. Silicone-based hard coatings prepared mainly from these coupling agents may also be used. Commercial hard coatings that maybe used include KP-85, X-40-9740, X-40-2239 (manufactured by Shinetsu Silicone) and AY42-440, AY42-441 and AY49-208 (manufactured by Dow Corning Toray).

A compound having two or more silicon atoms represented by the following formula (V) is preferably used in the resin forming the protective layer 614 for improving the strength of the protective layer 614.

B—(Si(R⁵¹)_{(3-d)}Qd)₂ (V)

wherein B represents a divalent organic group, R⁵¹ represents a hydrogen atom, an alkyl group or a substituted or unsubstituted aryl group, Q represents a hydrolysable group, and d is an integer of 1 to 3. More concretely, preferred examples of the compound of formula (V) include Compounds (V-1) to (V-16) shown in Table 1. In Table 1, Me indicates a methyl group, and Et indicates an ethyl group

TABLE 1

| | |
|---|---|
| V-1 | (MeO)₃Si—(CH₂)₂—Si(OMe)₃ |
| V-2 | (MeO)₂MeSi—(CH₂)₂—SiMe(OMe)₂ |
| V-3 | (MeO)₂MeSi—(CH₂)₆—SiMe(OMe)₂ |
| V-4 | (MeO)₃Si—(CH₂)₆—Si(OMe)₃ |
| V-5 | (EtO)₃Si—(CH₂)₆—Si(OEt)₃ |
| V-6 | (MeO)₂MeSi—(CH₂)₁₀—SiMe(OMe)₂ |
| V-7 | (MeO)₃Si—(CH₂)₃—NH—(CH₂)₃—Si(OMe)₃ |
| V-8 | (MeO)₃Si—(CH₂)₃—NH—(CH₂)₂—NH—(CH₂)₃—Si(OMe)₃ |
| V-9 | 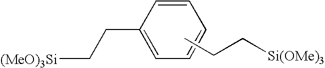 |
| V-10 | 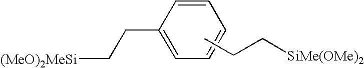 |
| V-11 | 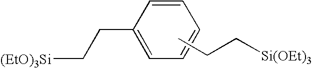 |
| V-12 | 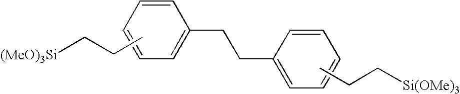 |
| V-13 | 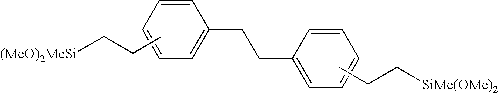 |
| V-14 | 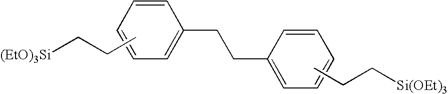 |
| V-15 | (MeO)₃SiC₃H₆—O—CH₂CH{—O—C₃H₆Si(OMe)₃}— |
| | CH₂{—O—C₃H₆Si(OMe)₃} |
| V-16 | (MeO)₃SiC₂H₄—SiMe₂—O—SiMe₂—O—SiMe₂—C₂H₄Si(OMe)₃ |

For control of film characteristics, prolongation of liquid life, etc., a resin soluble in an alcohol- or ketone-based solvent may be added. Such resin includes polyvinyl butyral resin, polyvinyl formal resin, polyvinyl acetal resin such as partially acetalated polyvinyl acetal resin having a part of butyral modified with formal, acetoacetal or the like (for example, S-LEC B and K manufactured by Sekisui Chemical Co., Ltd.), polyamide resin, cellulose resin, phenolic resin etc. Particularly, polyvinyl acetal resin is preferable from the standpoint of improvement in electric characteristics.

For the purpose of improving properties of the protective layer 614, such as discharging gas resistance, mechanical strength, mar resistance, particle dispersibility, viscosity control, torque reduction, abrasion control and prolongation of pot life, various resins may be added to the resin forming the protective layer 614. For example, a resin soluble in alcohol is preferably further added. The alcohol-soluble resin includes polyvinyl butyral resin, polyvinyl formal resin, polyvinyl acetal resin such as partially acetalated polyvinyl acetal resin having a part of butyral modified with formal, acetoacetal or the like (for example, S-LEC B, K etc. manufactured by Sekisui Chemical Co., Ltd.), polyamide resin, cellulose resin, etc. Particularly, polyvinyl acetal resin is preferable from the standpoint of improvement in electric characteristics.

The weight-average molecular weight of the resin forming the protective layer 614 is preferably 2000 to 100000, more preferably 5000 to 50000. When the weight-average molecular weight is less than 2000, the desired effect cannot be achieved, while when the molecular weight is greater than 100000, the solubility is decreased, the amount of the resin added is limited, and coating defects are caused upon coating. The amount of the resin added is preferably 1 to 40 wt %, more preferably 1 to 30 wt %, most preferably 5 to 20 wt %. When the amount is less than 1 wt %, the desired effect is hardly obtained, while when the amount is greater than 40 wt %, image blurring may easily occur under high temperature and high humidity.

For prolongation of pot life and control of film characteristics of the protective layer 614, a cyclic compound having a repeating structural unit represented by the following formula (VI), or a derivative of the compound, is desirably contained.

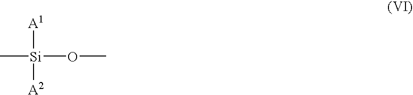

In the formula (VI), A¹ and A² independently represent a monovalent organic group. Examples of the cyclic compound having a repeating unit represented by the formula (VI) include commercially available cyclic siloxane compound. Specific examples of the cyclic siloxane compound include cyclic dimethylcyclosiloxane compounds such as hexamethylcyclotrisiloxane, octamethylcyclotetrasiloxane, decamethylcyclopentasiloxane and dodecamethylcyclohexasiloxane, cyclic methylphenylcyclosiloxane compounds such as 1,3,5-trimethyl-1,3,5-triphenylcyclotrisiloxane, 1,3,5,7-tetramethyl-1,3,5,7-tetraphenylcyclotetrasiloxane and 1,3,5,7,9-pentamethyl-1,3,5,7,9-pentaphenylcyclopentasiloxa ne, cyclic phenylcyclosiloxane compounds such as hexaphenylcyclotrisiloxane, fluorine atom-containing cyclosiloxane compounds such as 3-(3,3,3-trifluoropropyl)methylcyclotrisiloxane, hydrosilyl group-containing cyclosiloxane compounds such as a methylhydrosiloxane mixture, pentamethylcyclopentasiloxane and phenylhydrocyclosiloxane, and vinyl group-containing cyclosiloxane compounds such as pentavinylpentamethylcyclopentasiloxane. These cyclic siloxane compounds may be used solely or as a mixture of two or more thereof.

Various kinds of particles may be added to the resin forming the protective layer 614 for controlling the resistance to adhesion of contaminants, the lubricating property, the hardness and the like of the surface of the electrophotographic image carrier. For example, silicon atom-containing particles may be added. The silicon atom-containing particles are particles containing silicon as an element, and specific examples thereof include colloidal silica and silicone particles. The colloidal silica used as the silicon atom-containing particles has a volume-average particle diameter of preferably 1 nm to 100 nm, more preferably 10 nm to 30 nm and is selected from acidic or alkaline aqueous dispersions or those dispersed in an organic solvent such as alcohol, ketone and ester, and generally commercially available products may be used. The solid content of colloidal silica in the curing resin composition is not particularly limited, but is preferably in the range of 0.1 to 50 wt %, more preferably 0.1 wt % to 30 wt %, based on the solid content of the curing resin composition, from the viewpoint of film manufacturing, electric characteristics and strength. The silicone particles used as the silicon atom-containing particles have a volume-average particle diameter of preferably 1 to 500 nm, more preferably 10 nm to 100 nm, and are selected from spherical silicone resin particles, silicone rubber particles and silicone surface-treated silica particles, and generally commercially available products may be used. The silicone particles are chemically inert particles of small diameter excellent in dispersibility in resin, and the content of the silicone particles required for further achieving sufficient characteristics is low, so the surface state of the electrophotographic image carrier can be improved without inhibiting crosslinking reaction. That is, the silicone particles can be incorporated uniformly into the rigid crosslinking structure and can simultaneously improve lubricating properties and water repellence of the surface of the electrophotographic image carrier and maintain excellent abrasion resistance and stain resistance for a long time. The content of the silicone particles in the curing resin composition is preferably in the range of 0.1 wt % to 30 wt %, more preferably 0.5 wt % to 10 wt %, based on the total solid content of the curing resin composition.

Examples of other particles include fluorine particles such as particles obtained by polymerizing tetrafluoroethylene, trifluoroethylene, hexafluoropropylene, vinyl fluoride and vinylidene fluoride, and particles of a resin obtained by copolymerizing a fluorine resin and a monomer having a hydroxyl group, which is shown in Preprints of the 8th Polymer Material Forum, p. 89 and semi-electroconductive metal oxides such as ZnO—Al₂O₃, SnO₂—Sb₂O₃, In₂O₃—SnO₂, ZnO—TiO₂, MgO—Al₂O₃, FeO—TiO₂, TiO₂, SnO₂, In₂O₃, ZnO and MgO.

An oil such as a silicone oil may be added to the protective layer 614 for controlling the resistance to adhesion of contaminants, the lubricating property, the hardness and the like of the surface of the electrophotographic image carrier of the protective layer 614. Examples of the silicone oil include a silicone oil such as dimethylpolysiloxane, diphenylpolysiloxane and phenylmethylpolysiloxane, and a reactive silicone oil such as amino-modified polysiloxane, epoxy-modified polysiloxane, carboxyl-modified polysiloxane, carbinol-modified polysiloxane, methacrylic-modified polysiloxane, mercapto-modified polysiloxane and phenol-modified polysiloxane. The oil may be added in advance to the curing resin composition for forming the protective layer 614 or may be impregnated into the protective layer under reduced pressure or increased pressure after producing the image carrier.

The protective layer 614 may contain additives such as a plasticizer, a surface improving agent, an antioxidant and a light degradation preventing agent. Examples of the plasticizer include biphenyl, biphenyl chloride, terphenyl, dibutyl phthalate, diethylene glycol phthalate, dioctyl phthalate, triphenyl phosphate, methylnaphthalene, benzophenone, chlorinated paraffin, polypropylene, polystyrene and various kinds of fluorohydrocarbons.

An antioxidant having a hindered phenol, hindered amine, thioether or phosphite partial structure may be added to the protective layer 614, and is effective in improving potential stability and image qualities when the environment is changed. The antioxidant includes, for example, Sumilizer BHT-R, Sumilizer MDP-S, Sumilizer BBM-S, Sumilizer WX-R, Sumilizer NW, Sumilizer BP-76, Sumilizer BP-101, Sumilizer GA-80, Sumilizer GM and Sumilizer GS, all produced by Sumitomo Chemical Co., Ltd., IRGANOX 1010, IRGANOX 1035, IRGANOX 1076, IRGANOX 1098, IRGANOX 1135, IRGANOX 1141, IRGANOX 1222, IRGANOX 1330, IRGANOX 1425WL, IRGANOX 1520L, IRGANOX 245, IRGANOX 259, IRGANOX 3114, IRGANOX 3790, IRGANOX 5057 and IRGANOX 565, all produced by Chiba Specialty Chemicals, Inc., and ADEKA STUB AO-20, ADEKA STUB AO-30, ADEKA STUB AO-40, ADEKA STUB AO-50, ADEKA STUB AO-60, ADEKA STUB AO-70, ADEKA STUB AO-80 and ADEKA STUB AO-330, all produced by Asahi Denka Co., Ltd. Examples of the commercially available hindered amine antioxidant include Sanol LS2626, Sanol LS765, Sanol LS770 and Sanol LS744, all produced by Sankyo Lifetech Co., Ltd., TINUVIN 144 and TINUVIN 622LD, all produced by Chiba Specialty Chemicals, Inc., MARK LA57, MARK LA67, MARK LA62, MARK LA68 and MARK LA63, all produced by Asahi Denka Co., Ltd. and Sumilizer TPS, produced by Sumitomo Chemical Co., Ltd. Examples of the commercially available thioether antioxidant include Sumilizer TP-D, produced by Sumitomo Chemical Co., Ltd. Examples of the commercially available phosphite antioxidant include MARK 2112, MARK PEP-8, MARK PEP-24G, MARK PEP-36, MARK 329K and MARK HP-10, all produced by Asahi Denka Co., Ltd. Particularly, hindered phenol or hindered amine antioxidants are preferable among the antioxidants having a hindered phenol, hindered amine, thioether or phosphite partial structure. These may be modified with substituent groups such as an alkoxysilyl group capable of crosslinkage reaction with a material forming a crosslinked film.

When a resin having a crosslinked structure, such as phenolic resin, melamine resin or benzoguanamine resin is used as the resin forming the protective layer 614, the catalyst used for producing the resin is removed. For this removal, it is preferable that the resin is dissolved in a suitable solvent such as methanol, ethanol, toluene or ethyl acetate and washed with water or re-precipitated with a poor solvent, or treated with any of the following materials: Such materials are exemplified by a cation exchange resin such as Amberlite 15, Amberlite 200C and Amberlist 15E, all produced by Rohm & Haas Company, Dowex MWC-1-H, Dowex 88 and Dowex HCR-W2, all produced by Dow Chemical Company, Lewatit SPC-108 and Lewatit SPC-118, produced by Bayer AG, Diaion RCP-150H, produced by Mitsubishi Chemical Corp., Sumikaion KC-470, Duolite C26-C, Duolite C-433 and Duolite 464, all produced by Sumitomo Chemical Co., Ltd., and Nafion-H produced by DuPont, and an anion exchange resin such as Amberlite IRA-400 and Amberlite IRA-45, all produced by Rohm & Haas Company; an inorganic solid having a group containing a protonic acid bonded on the surface thereof, such as Zr(O₃PCH₂CH₂SO₃H)₂ and Th(O₃PCH₂CH₂COOH)₂; polyorganosiloxane containing a protonic acid, such as polyorganosiloxane having a sulfonic acid group; a heteropoly acid such as cobalt tungstate and phosphorous molybdate; isopoly acid such as niobic acid, tantalic acid and molybdic acid; a monoelemental metallic oxide such as silica gel, alumina, chromia, zirconia, CaO and MgO; a complex metallic oxide such as silica-alumina, silica-magnesia, silica-zirconia and zeolite; a clay mineral such as acid clay, activated clay, montmorillonite and kaolinite; a metallic sulfate such as LiSO₄ and MgSO₄; a metallic phosphate such as zirconium phosphate and lanthanum phosphate; a metallic nitrate such as LiNO₃ and Mn(NO₃)₂; an inorganic solid having a group containing an amino group bonded on the surface thereof, such as a solid obtained by reacting aminopropyltriethoxysilane on silica gel; and polyorganosiloxane containing an amino group, such as amino-modified silicone resin.

An epoxy-containing compound such as polyglycidyl methacrylate, glycidyl bisphenol and phenol-epoxy resin or terephthalic acid, maleic acid, pyromellitic acid, biphenyltetracarboxylic acid or an anhydride thereof may be added to the protective layer 614 in order to control film properties such as the hardness, the adhesiveness and the flexibility of the layer. The amount of such an additive may be from 0.05 to 1 part by weight, preferably from 0.1 to 0.7 part by weight, relative to 1 part by weight of the additive for the electrophotographic image carrier of the invention.

The protective layer 614 may be mixed at an arbitrary ratio with an insulating resin such as a polyvinyl butyral resin, a polyarylate resin (for example a polycondensate of bisphenol A and phthalic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin and a polyvinylpyrrolidone resin. Coating defects due to adhesion to the charge-transporting layer 613, thermal shrinkage and cissing can thereby be prevented.

As described above, the protective layer 614 is formed by applying a protective layer-forming coating liquid containing the respective materials described above and then curing it. In this protective layer-forming coating liquid, solvents, for example, an alcohol such as methanol, ethanol, propanol and butanol, a ketone such as acetone and methyl ethyl ketone, and an ether such as tetrahydrofuran, diethyl ether and dioxane may be used depending on necessity. Other various kinds of solvents may be used, but in the case where the dip coating method generally used for producing an electrophotographic image carrier is employed, an alcohol solvent, a ketone solvent or a mixed solvent thereof is preferably used. The solvent used preferably has a boiling point of from 50 to 150° C., and can be arbitrarily mixed for use. The amount of the solvent may be arbitrarily established, but when the amount is too low, precipitation easily occurs, so it is preferable that the amount of the solvent is preferably 0.5 to 30 parts by weight, preferably 1 to 20 parts by weight, relative to 1 part by weight of solids contained in the protective layer-forming coating liquid.

When the resin forming the protective layer 614 is allowed to have a crosslinked structure, a curing catalyst may be used in the protective layer-forming coating liquid. Preferred examples of the curing catalyst include a photo-acid generator such as bissulfonyldiazomethanes such as bis(isopropylsulfonyl)diazomethane; bissulfonylmethanes such as methylsulfonyl p-toluenesulfonylmethane; sulfonylcarbonyldiazomethanes such as cyclohexylsulfonylcyclohexylcarbonyldiazomethane; sulfonylcarbonylalkanes such as 2-methyl-2-(4-methylphenylsulfonyl)propiophenone; nitrobenzyl sulfonates such as 2-nitrobenzyl p-toluenesulfonate; alkyl and aryl sulfonates such as pyrogallol trismethanesulfonate; benzoin sulfonates such as benzoin tosylate; N-sulfonyloxyimides such as N-(trifluoromethylsulfonyloxy)phthalimide; pyridones such as (4-fluorobenzenesulfonyloxy)-3,4,6-trimethyl-2-pyridone; sulfonates such as 2,2,2-trifluoro-1-trifluoromethyl-1-(3-vinylphenyl)-ethyl 4-chlorobenzenesulfonate; onium salts such as triphenylsulfonium methanesulfonate and diphenyliodonium trifluoromethanesulfonate, as well as compounds prepared through neutralization of a proton acid or a Lewis acid with a Lewis base, mixtures of Lewis acid and trialkyl phosphate, sulfonates, phosphates, onium compounds, and anhydrous carboxylic acid compounds. The compounds prepared through neutralization of a proton acid or a Lewis acid with a Lewis base are for example those prepared by neutralizing halogenocarboxylic acids, sulfonic acids, sulfuric monoesters, phosphoric mono or diesters, polyphosphates or boric mono or diesters with various amines such as ammonia, monoethylamine, triethylamine, pyridine, piperidine, aniline, morpholine, cyclohexylamine, n-butylamine, monoethanolamine, diethanolamine, triethanolamine, or with trialkyl phosphine, triaryl phosphine, trialkyl phosphite, triaryl phosphite; and commercial products of acid-base block catalysts such as Neicure 2500X, 4167, X-47-110, 3525, 5225 (King Industries' trade names). The compounds prepared through neutralization of a Lewis acid with a Lewis base include, for example, those prepared by neutralizing a Lewis acid such as BF₃, FeCl₃, SnCl₄, AlCl₃ or ZnCl₂ with any of the above-mentioned Lewis bases. Examples of the onium compound include triphenylsulfonium methanesulfonate, diphenyliodoniumtrifluoromethanesulfonate, etc. Examples of the anhydrous carboxylic acid compound include acetic anhydride, propionic anhydride, butyric anhydride, isobutyric anhydride, lauric anhydride, oleic anhydride, stearic anhydride, n-caproic anhydride, n-caprylic anhydride, n-capric anhydride, palmitic anhydride, myristic anhydride, trichloroacetic anhydride, dichloroacetic anhydride, monochloroacetic anhydride, trifluoroacetic anhydride, and heptafluorobutyric anhydride. Examples of the Lewis acid include metal halides such as boron trifluoride, aluminium trichloride, titanous chloride, titanic chloride, ferrous chloride, ferric chloride, zinc chloride, zinc bromide, stannous chloride, stannic chloride, stannous bromide and stannic bromide; organometallic compounds such as trialkylboron, trialkylaluminium, dialkyl-halogenoaluminium, monoalkyl-halogenoaluminium, and tetraalkyltin; metal chelate compounds such as diisopropxyethyl acetacetatoaluminium, tris(ethylacetacetato)aluminium, tris(acetylacetonato)aluminium, diisopropoxy-bis(ethylacetacetato)titanium, diisopropxy-bis(acetylacetonato)titanium, tetrakis(n-propylacetacetato)zirconium, tetrakis(acetyladetonato)zirconium, tetrakis(ethylacetacetato)zirconium, dibutyl-bis(acetylacetonato)tin, tris(acetylacetonato)iron, tris(acetylacetonato)rhodium, bis(acetylacetonato)zinc, and tris(acetylacetonato)cobalt; and metal soaps such as dibutyltin dilaurate, dioctyltin maleate, magnesium naphthenate, calcium naphthenate, manganese naphthenate, iron naphthenate, cobalt naphthenate, copper naphthenate, zinc naphthenate, zirconium naphthenate, lead naphthenate, calcium octylate, manganese octylate, iron octylate, cobalt octylate, zinc octylate, zirconium octylate, tin octylate, lead octylate, zinc octylate, magnesium stearate, aluminium stearate, calcium stearate, cobalt stearate, zinc stearate, and lead stearate. One or more of these may be used herein either singly or as combined. Though not specifically defined, the amount of the catalyst to be used is preferably from 0.1 to 20 parts by weight, more preferably from 0.3 to 10 parts by weight, relative to 100 parts by weight of the total solid content in the protective layer-forming coating liquid.

When the protective layer-forming coating liquid is applied onto the charge-transporting layer 613, ordinary methods such as a blade coating method, a wire bar coating method, a spray coating method, a dip coating method, a bead coating method, an air knife coating method and a curtain coating method may be used as the coating method. After coating the protective layer 614 is formed by drying the coating film. In the case where film thickness cannot be obtained to the necessary level by a one-time coating operation, the necessary thickness may be obtained by repeating the coating operation. In the case where the coating operation is repeated, a heating operation may be effected per respective coating operations or may be effected after performing plural coating operations. When the protective layer 614 is formed of a resin having a crosslinked structure, the resin is preferably crosslinked at a curing temperature of from 100° C. to 170° C., more preferably from 100° C. to 160° C. The curing time is preferably from 30 minutes to 2 hours, more preferably from 30 minutes to 1 hour. The heating temperature may be stepwise varied. The crosslinking reaction is carried out in a gas atmosphere inert to oxidation, such as nitrogen, helium or argon, whereby the electric properties of the film can be prevented from being worsened. When the crosslinking reaction is effected in such an inert gas atmosphere, then the curing temperature may be set higher than in an air atmosphere. Preferably, the curing temperature is from 100 to 180° C., more preferably from 110 to 160° C. The curing time is preferably from 30 minutes to 2 hours, more preferably from 30 minutes to 1 hour.

Preferably, the thickness of the protective layer 614 is from 0.5 to 15 μm, more preferably from 1 to 10 μm, even more preferably 1 to 5 μm.

The oxygen transmission coefficient of the protective layer 614 at 25° C. is 4×10¹² fm/s·Pa or less, more preferably 3.5×10¹² fm/s·Pa or less, still more preferably 3×10¹² fm/s·Pa or less. The oxygen transmission coefficient is a criterion that indicates the easiness of oxygen gas transmission through the layer, but on the other hand, it may be considered as a characteristic factor substitutive for the physical porosity of the layer. When the type of the gas that passes through the layer varies, then the absolute value of the gas transmittance of the layer may vary. In any case, however, there is almost no inversion in the level of gas transmission between the layers tested. Accordingly, the gas transmission coefficient may be interpreted as a criterion that indicates the easiness of ordinary gas transmission through a layer. When the oxygen transmission coefficient of the protective layer 614 at 25° C. is in the range defined above, the protective layer 614 is hardly permeated with a gas. Accordingly, permeation of corona products generated in the image-forming process is suppressed, and compounds contained in the protective layer 614 are prevented from being deteriorated, and thus the electrical property thereof can be kept at high level, and high-quality image formation and long-life operation can be effectively attained.

The forgoing is an explanation of the image carrier 61 arranged in the image forming apparatus 1 in FIG. 1. Then, the toner used in the image forming apparatus 1 will be described.

The toner used in the image forming apparatus in FIG. 1 is a toner having a mean shape factor 1 (SF1) (SF1=ML²/A×π/4×100 wherein ML represents the maximum length of the particle and A represents the projected area of the particle) of 100 to 140. The mean shape factor (SF1) is determined by measuring an image of toner particles mounted on a slide glass via a video camera by an optical microscope, incorporating the image into an image analyzer (trade name: LUZEX III, manufactured by NIRECO Corporation), calculating the maximum length (ML) and projected area (A) of the toner, and assigning these values to the above equation to determine the shape factor. The mean shape factor is the mean shape factor of arbitrary 100 toner particles, as determined from the above equation. The volume-average particle size of the toner used in the image forming apparatus in FIG. 1 is preferably 2 to 12 μm, more preferably from 3 to 12 μm, even more preferably from 3 to 9 μm. Use of the toner that satisfies the mean shape factor and the volume-average particle size ensures good developability and transferability and gives high-quality images. The toner used in the image forming apparatus 1 in FIG. 1 is not particularly limited with respect to its production method so far as it satisfies the mean shape factor and volume-average particle size described above. For example, the toner used in the image forming apparatus 1 in FIG. 1 may be produced by using a method such as a kneading and grinding method of kneading a binder resin, a colorant and a lubricant and optionally an antistatic agent, then grinding the mixture and classifying it; a method of further processing the particles obtained by the kneading and grinding method, by applying mechanical shock or thermal energy thereto to change their shape; an emulsion polymerization aggregation method of mixing a dispersion that is formed through emulsion polymerization of a polymerizing monomer for a binder resin, with a colorant and a lubricant and optionally an antistatic agent, and aggregating and fusing it under heat to obtain toner particles; a suspension polymerization method of suspending a solution of a polymerizing monomer for a binder resin, and a colorant and a lubricant, and optionally an antistatic agent, in an aqueous solvent and polymerizing it; and a solution suspension method of suspending a solution of a binder resin, a colorant and a lubricant and optionally an antistatic agent, in an aqueous solvent and granulating it. In addition, any other known method is also employable herein, for example, a method of producing core/shell toner particles that comprises adhering aggregated particles to the core toner particles obtained according to the method as above, and heating and fusing them to give toner particles having a core/shell structure. For producing the toner for use herein, especially preferred are the suspension polymerization method, the emulsion polymerization aggregation method and the solution suspension method in which the toner particles are produced in an aqueous solvent, since the methods facilitate shape control and particle size distribution control; and more preferred is the emulsion polymerization aggregation method.

The toner base particles used in the image forming apparatus 1 in FIG. 1 comprise a binder resin, a colorant and a lubricant, and is produced if necessary by adding external additives such as silica and an antistatic agent. The binder resin for the toner base particles includes homopolymers and copolymers of styrenes such as styrene and chlorostyrene; monoolefins such as ethylene, propylene, butylene and isoprene; vinyl esters such as vinyl acetate, vinyl propionate, vinyl benzoate, and vinyl butyrate; α-methylene-aliphatic monocarboxylates such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate; vinyl ethers such as vinyl methyl ether, vinyl ethyl ether, and vinyl butyl ether; vinyl ketones such as vinyl methyl ketone, vinyl hexyl ketone, and vinyl isopropenyl ketone; and polyester resins formed through copolymerization of dicarboxylic acids and diols. Other examples of the binder resin include polystyrene, styrene-alkyl acrylate copolymers, styrene-alkyl methacrylate copolymers, styrene-acrylonitrile copolymers, styrene-butadiene copolymers, styrene-maleic anhydride copolymers, polyethylene, polypropylene and polyester resins. Further examples can include polyurethane, epoxy resins, silicone resins, polyamides, modified rosins, and paraffin wax. Typical examples of the colorant include magnetic powders such as magnetite and ferrite, as well as carbon black, aniline blue, calyl blue, chrome yellow, ultramarine blue, DuPont oil red, quinoline yellow, methylene blue chloride, phthalocyanine blue, malachite green oxalate, lamp black, rose bengal, C.I. Pigment Red 48:1, C.I. Pigment Red 122, C.I. Pigment Red 57:1, C.I. Pigment Yellow 97, C.I. Pigment Yellow 17, C.I. Pigment Blue 15:1 and C.I. Pigment Blue 15:3. Typical examples of the lubricant include low-molecular polyethylene, low-molecular polypropylene, Fischer-Tropsch wax, montan wax, carnauba wax, rice wax, and candelilla wax. The antistatic agent used in the toner base particles may be any known one, and for example, azo-type metal complex compounds, salicylate metal complex compounds, and polar group-containing resin-type antistatic agents may be used. When the toner is produced according to a wet process, then it is desirable to use hardly water-soluble materials from the viewpoint of ionic strength control and reduction in waste pollution. The toner may be either a magnetic toner that contains a magnetic material or a non-magnetic toner not containing a magnetic material.

The toner for use in the image forming apparatus 1 in FIG. 1 may be produced by mixing the toner base particles and the external additives mentioned above in a Henschel mixer or a V blender. When the toner base particles are produced in a wet process, the external additives may be added thereto also in a wet process.

Lubricant particles may be added to the toner for use in the image forming apparatus 1 in FIG. 1. The lubricant particles usable herein include solid lubricants such as graphite, molybdenum disulfide, talc, fatty acids, and metal salts of fatty acids; low-molecular-weight polyolefins such as polypropylene, polyethylene, and polybutene; silicones having a softening point under heat; fatty acid amides such as oleamide, erucamide, ricinoleamide, and stearamide; vegetable waxes such as carnauba wax, rice wax, candelilla wax, haze wax, and jojoba oil; animal waxes such as bees wax; mineral petroleum waxes such as montan wax, ozokerite, ceresin, paraffin wax, microcrystalline wax, and Fisher-Tropsch wax; and their modified derivatives. These may be used alone or as a mixture of two or more thereof. Preferably, the lubricant particles have a volume-average particle size of from 0.1 to 10 μm. The substances having the above-mentioned chemical structure may be ground and dressed into particles having a uniform particle size. The amount of the lubricant particles to be added to the toner is preferably from 0.05 to 2.0% by weight, more preferably from 0.1 to 1.5% by weight.

Inorganic particles, organic particles, or composite particles prepared by adhering inorganic particles to organic particles may be added to the toner for use in the image forming apparatus 1 in FIG. 1, for the purpose of removing sticky substances or degraded substances from the surface of the electrophotographic image carrier. The inorganic particles that can be preferably used include various inorganic oxides, nitrides and borides such as silica, alumina, titania, zirconia, barium titanate, aluminium titanate, strontium titanate, magnesium titanate, zinc oxide, chromium oxide, cerium oxide, antimony oxide, tungsten oxide, tin oxide, tellurium oxide, manganese oxide, boron oxide, silicon carbide, boron carbide, titanium carbide, silicon nitride, titanium nitride, and boron nitride. The inorganic particles may be treated with a titanium coupling agent such as tetrabutyl titanate, tetraoctyl titanate, isopropyltriisostearyl titanate, isopropyltridecyl benzenesulfonyltitanate, and bis(dioctylpyrophosphate)oxyacetate titanate, or with a silane coupling agent such as γ-(2-aminoethyl)aminopropyltrimethoxysilane, γ-(2-aminoethyl)aminopropylmethyldimethoxysilane, γ-methacryloxypropyltrimethoxysilane, N-β-(N-vinylbenzylaminoethyl)-γ-aminopropyltrimethoxysilane hydrochloride, hexamethyldisilazane, methyltrimethoxysilane, butyltrimethoxysilane, isobutyltrimethoxysilane, hexyltrimethoxysilane, octyltrimethoxysilane, decyltrimethoxysilane, dodecyltrimethoxysilane, phenyltrimethoxysilane, o-methylphenyltrimethoxysilane, and p-methylphenyltrimethoxysilane. Those treated for hydrophobication with silicone oil or a higher fatty acid metal salt such as aluminium stearate, zinc stearate or calcium stearate are also preferably used herein.

The organic particles include styrene resin particles, styrene-acrylic resin particles, polyester particles and urethane particles.

Preferably, the volume-average particle size of the particles added to the toner used in the image forming apparatus 1 in FIG. 1 is from 5 nm to 1000 nm, more preferably from 5 nm to 800 nm, even more preferably from 5 nm to 700 nm. If the volume-average particle size thereof is smaller than the lowermost limit, then the abrasive capability of the particles may be poor; but if larger than the uppermost limit, then the particles may scratch the surface of the electrophotographic image carrier. Preferably, the total amount of the above-mentioned additive particles and the lubricant particles is at least 0.6% by weight.

Regarding other inorganic oxides to be added to the toner used in the image forming apparatus 1 in FIG. 1, it is desirable that small-size inorganic oxide particles having a primary particle size of at most 40 nm are added thereto for powdery flowability and charge control and inorganic oxide particles larger than 40 nm are added for stickiness reduction and charge control. For such inorganic oxide particles, any known ones may be used. For these, preferred is a combination of silica and titanium oxide for precision charge control. Surface treatment of the small-size inorganic particles increases the dispersibility of the particles, and the resulting particles are more effective for enhancing the powdery flowability of toner. In addition, carbonates such as calcium carbonate and magnesium carbonate, as well as inorganic minerals such as hydrotalcite are also preferred for use in the toner for the purpose of removing discharged substances.

A carrier for carrying the toner in the image forming apparatus 1 in FIG. 1 includes iron powder, glass beads, ferrite powder, nickel powder, and those covered with resin. The blend ratio of the toner and the carrier may be suitably established.

The foregoing is a description of the image forming apparatus 1 in FIG. 1 and each element forming the image forming apparatus 1 in FIG. 1.

An image carrier having a layer structure different from the layer structure shown in FIG. 5 may be used in the process cartridge and the image forming apparatus according to the invention. Hereinafter, such image carrier is described.

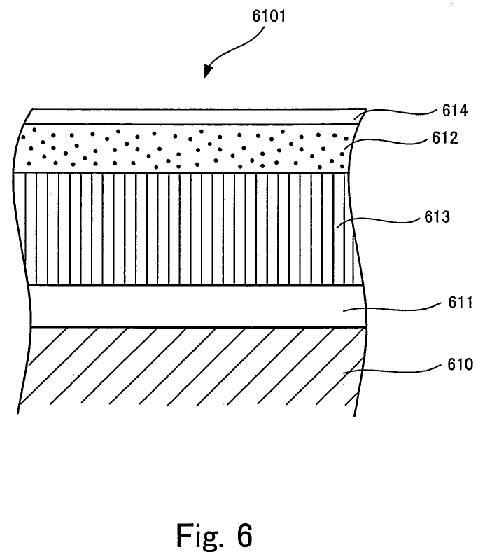

FIGS. 6 to 9 show layer structures of image carriers that are modifications to the image carrier shown in FIG. 5.

In FIGS. 6 to 9, the same elements as those in the image carrier 61 in FIG. 5 are denoted by the same reference numerals, and their description are omitted.

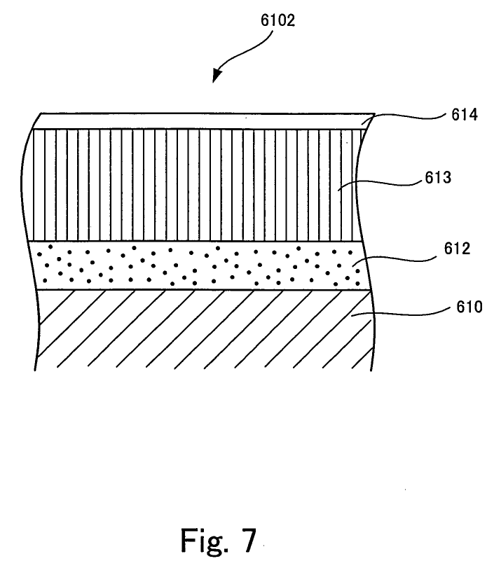

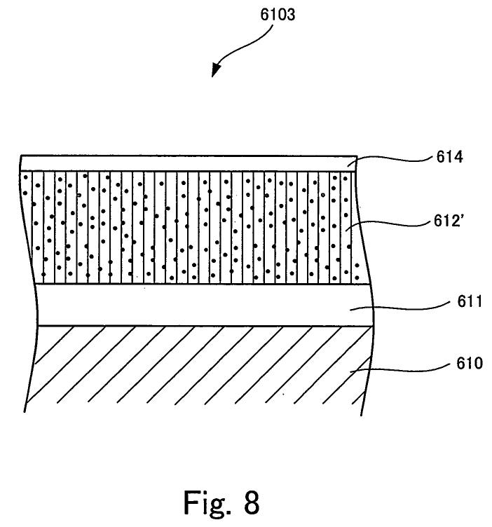

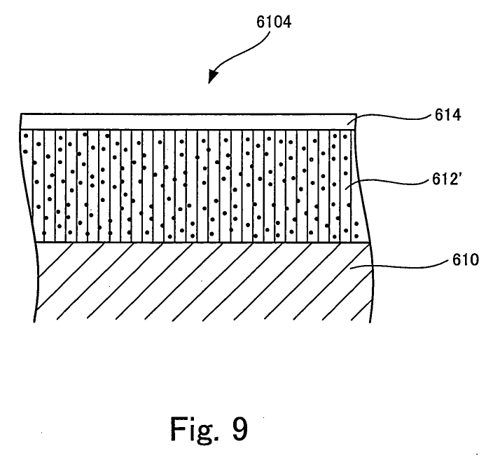

The image carrier 6101 shown in FIG. 6 is the same as the image carrier 61 in FIG. 5 except that the position of the charge-generating layer 612 is replaced with the position of the charge-transporting layer 613, and the image carrier 6102 shown in FIG. 7 is the same as the image carrier 61 in FIG. 5 except that the image carrier 6102 lacks the undercoat layer 611. The image carrier 6103 shown in FIG. 8 is the same as the image carrier 61 in FIG. 5 except that the charge-generating layer 612 and the charge-transporting layer 613 are integrated into the photosensitive layer 612′, and the photosensitive layer 612′ acts as both the charge-generating layer 612 and the charge-transporting layer 613 shown in FIG. 5. The image carrier 6104 shown in FIG. 9 is the same as the image carrier 6103 in FIG. 8 except that the image carrier 6104 lacks the undercoat layer 611. In the image carriers 6103 and 6104 shown in FIGS. 8 and 9, the photosensitive layer 612′ is formed by incorporating the charge-generating material and the binder resin. That is, the charge-generating material may be the same as the one in the charge-generating layer 612, and the binder resin may be the same as the one in the charge-generating layer 612 and in the charge-transporting layer 613. The content of the charge-generating material in the photosensitive layer 612′ is preferably 10 to 85% by weight, more preferably 20 to 50% by weight, based on the total solid content of the charge-generating layer 612. For the purpose of improving photoelectric characteristics etc., the charge-transporting material and the charge-transporting polymer material may be added to the photosensitive layer 612′. The amount of such materials added is preferably 5 to 50% by weight based on the total solid content of the single-layer photosensitive layer. The solvent used in coating, and the coating method, may be those used in each of the layers described above. The thickness of the photosensitive layer 612′ is preferably 5 to 50 μm, more preferably 10 to 40 μm.

For the purpose of preventing the deterioration of the image carrier by ozone and an oxidizing gas generated in a copier or by light or heat, additives such as an antioxidant, a light stabilizer and a heat stabilizer may be added to the photosensitive layer 612′. For example, the antioxidant includes hindered phenol, hindered amine, paraphenylene diamine, aryl alkane, hydroquinone, spirochroman, spiroindanone and derivatives thereof, organic sulfur compounds, organic phosphorous compounds, etc. Examples of the light stabilizer include derivatives such as benzophenone, benzotriazole, dithiocarbamate and tetramethyl piperidine. For the purpose of improvement in sensitivity, reduction in residual potential, reduction in fatigue upon repeated use, etc., at least one kind of electron receptor may be contained in the photosensitive layer 612′. The electron receptor includes, for example, succinic anhydride, maleic anhydride, dibromomaleic anhydride, phthalic anhydride, tetrabromophthalic anhydride, tetracyanoethylene, tetracyanoquinodimethane, o-dinitrobenzene, m-dinitrobenzene, chloranil, dinitroanthraquinone, trinitrofluorenone, picric acid, o-nitrobenzoic acid, p-nitrobenzoic acid, and phthalic acid. Among these compounds, fluorenone- and quinone-based electron receptors and benzene derivatives having electron attractive substituent groups such as Cl, CN and NO₂ are particularly preferable.

For the layer structure of the image carrier, the image carrier whose functions are separated and assigned to the charge-generating layer 612 and the charge-transporting layer 613, such as in the image carriers 61, 6101 and 6102 shown in FIGS. 5 to 7, is preferred to the image carrier provided with the photosensitive layer 612′ in which the charge-generating layer 612 and the charge-transporting layer 613 are integrated, because the two layers each have a specialized function thereby making the image carrier highly functional.

The image carriers shown in FIGS. 6 to 9 are used in place of the image forming apparatus 1000 shown in FIG. 1 and the image carrier 61 in the process cartridges 100K, 100Y, 100M and 100C for each color in the image forming apparatus 1000, thereby realizing another exemplary embodiment of the image forming apparatus and the process cartridge of the invention. The image forming apparatus and the process cartridge in these exemplary embodiments are the same as the image forming apparatus 1000 shown in FIG. 1 and the process cartridge for each color in the image forming apparatus 1 except that they are different in the image carrier, so a description thereof is omitted.

In the image forming apparatus described above, a tandem system is used as shown in FIG. 1, but in the image forming apparatus of the invention, a rotary system may also be used. In the following description, another exemplary embodiment of the image forming apparatus of the invention using a rotary system is described.

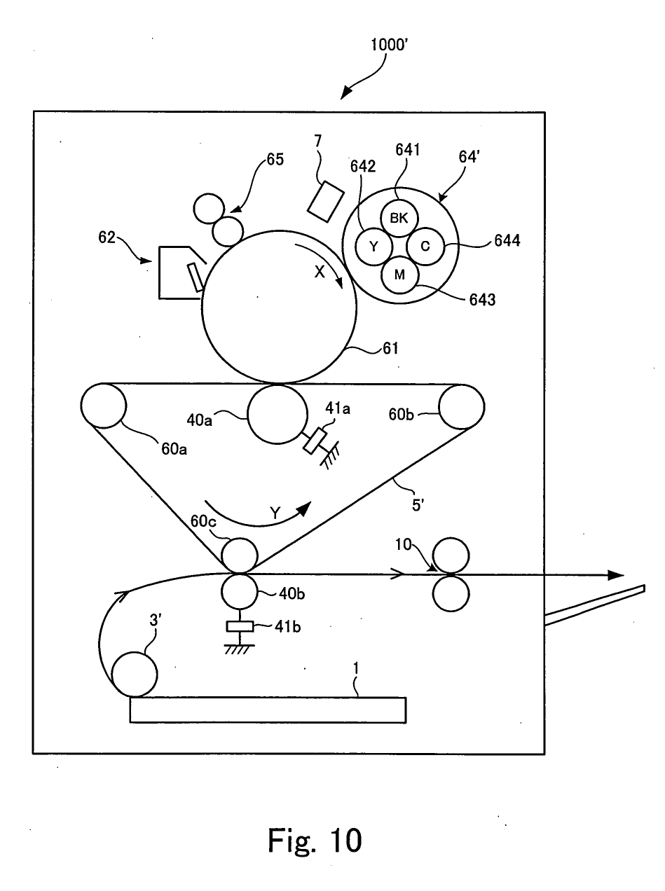

FIG. 10 shows a schematic block diagram of the image forming apparatus in a rotary system corresponding to another exemplary embodiment of the image forming apparatus of the invention.

The image forming apparatus 1000′ shown in FIG. 10 is a color printer using a rotary system. In FIG. 10, elements common to those of the image forming apparatus 1000 shown in FIG. 1 are provided with the same symbols as in FIG. 1. The image forming apparatus 1000′ is provided with an image carrier 61 and an intermediate transfer belt 5′. As described above, the image carrier 61 is the same as the image carriers 61K, 61C, 61M and 61Y in FIG. 1 (that is, the image carrier 61 in FIGS. 2 and 5), and at the time of image formation, the image carrier rotates in the direction X shown by an arrow in the figure. The intermediate transfer belt 5′ is an endless belt member stretched with backup rolls 60a, 60b and 60c, and moves in accordance with the image carrier 61 at the time of image formation, and rotates and moves in the direction Y shown in an arrow in the figure. A primary transfer roll 40a is arranged at a position opposite to the image carrier 61 behind the intermediate transfer belt 5′, and a second transfer roll 40b is arranged below it (lower side of the figure). These receives bias voltages from the primary transfer bias voltage-applying part 41a and secondary transfer bias voltage-applying part 41b.

The image carrier 61 is provided therearound with a developing rotary 64′, a charging device 65, a light exposure section 7 and a cleaning device 62. The charging device 65 shown in FIG. 10 is a contact-type charging device which while contacting the image carrier 61, charges the image carrier 61, and is the same as the charging devices 65K, 65C, 65M and 65Y in the image forming apparatus 1000 in FIG. 1 (that is, the charging device 65 shown in FIGS. 2 and 3). The developing rotary 64′ is a rotary composite developing device wherein development units 641 to 644 accommodating color toners of black (BK), yellow (Y), magenta (M), and cyan (C) are arranged in the circumferential direction, and by rotation of the developing rotary 64′, the development unit performing development by coming close to the image carrier 61 can be changed to another development unit. Each color toner has a charging property of being negatively charged, and external additive particles such as a lubricant and a transfer assistant which are smaller than the toner particles are added onto each color toner. The light exposure section 7 plays a role in irradiating the surface of the image recording body 61 with a laser light, and the cleaning device 62 plays a role in removing the toner on the image carrier 61.

Then, the work of image formation in the image forming apparatus 1000′ is described.

An image is formed by inputting image information on one or more images, having image signals of four colors of yellow, magenta, cyan, and black to the image forming apparatus 1000′. When these image signals are inputted, the image carrier 61 is initiated to rotate, and the surface of the rotating image carrier 61 is charged by the charging device 65. Among four-color image signals inputted, the image recording body 61 is irradiated with a laser light corresponding to a cyan image signal, from the light exposure section 7, and upon this irradiation, an electrostatic latent image of potential higher than its surrounding area is formed on the surface of the image carrier 61. By rotation of the developing rotary 64′, the developing device 644 accommodating a cyan toner comes close to the image carrier 61 and develops the electrostatic latent image with a cyan toner. When this electrostatic latent image is developed, the developing device 644 accommodating a cyan toner receives a bias voltage from a developing bias voltage-applying section (not shown), whereby the potential of the developing device 644 has a potential lower than the potential of the electrostatic latent image and higher than the image carrier 61. It follows that due to the potential difference between the electrostatic latent image and the developing device 644 accommodating a cyan toner, the cyan toner in the developing device 644 is removed from the developing device 644 and adheres to the electrostatic latent image thereby developing the electrostatic latent image to form a cyan developed image on the image carrier 61.

Then, the formed cyan developed image is subjected to primary transfer via the primary transfer roll 40a from the image carrier 61 to the intermediate transfer belt 5′, to form a cyan transferred image on the intermediate transfer belt 5′. For this primary transfer, the primary bias voltage-applying part 41a applies bias voltage to the primary transfer roll 40a such that the potential of the primary transfer roll 40a is made higher than the potential on the image carrier 61 on which the cyan developed image is positioned, whereby the above primary transfer can be realized.

Residual substances such as a residual toner remaining without primary transfer and external additive particles are present on the image carrier 61, and these residual substances are removed from the image carrier 61 by the cleaning device 62.

After the residual substances are removed by the cleaning device 62, the surface of the image carrier 61 is again charged uniformly with the charging device 65, and by rotation of the developing rotary 64′, the developing device 643 accommodating a magenta toner is then comes close to the image carrier 61, and a magenta developed image is formed in the same manner as for the cyan developed image described above. Formation of this magenta developed image is carried out in such timing that when the cyan transferred image on the intermediate transfer belt 5′ after passing through backup rolls 60a, 60b and 60c is returned, after primary transfer, to the position of the primary transfer roll 40a, the formed magenta developed image is superimposed by primary transfer onto the cyan transferred image. After the magenta transferred image is formed by superimposing the magenta developed image via primary transfer onto the cyan transferred image, a yellow developed image and a black developed image are also formed in the same manner as above and superimposed by primary transfer onto the magenta transferred image and cyan transferred image. As a result, a multicolor primary transfer image having the primary transfer images of the respective colors of cyan, magenta, yellow and black superimposed thereon is formed on the intermediate transfer belt 5′.

Subsequently, this multicolor primary transfer image in a position between the secondary transfer roll 40b and the backup roll 60c is secondarily transferred onto a paper fed with a paper feed roll 3′ from tray 1, to form a secondary transfer image. For this secondary transfer, the secondary transfer bias voltage-applying part 41b applies bias voltage to the secondary transfer roll 40b such that the potential of the secondary transfer roll 40b is made higher than the potential on the intermediate transfer belt 5′ on which the multicolor primary transfer image is positioned, whereby the above secondary transfer can be realized.

The paper onto which the multicolor primary transfer image was secondarily transferred is heated and pressurized with a fixing device 10 arranged rightward apart from the secondary transfer roll 40b in FIG. 10, thereby fixing the secondary transfer image. Then, the paper subjected to fixation treatment is outputted from the right side of the image forming apparatus as shown by an arrow in the figure.

The image forming apparatus 1000′ in FIG. 10 is also provided with the charging device 65 shown in FIGS. 2 and 3, whereby the charging member 20 possessed by the charging device 65 (see FIGS. 2 and 3) is smoothly cleaned by the cleaning member 21 (see FIGS. 2 and 3) thereby preventing image defects due to vibration of the cleaning member 21. As a result, an excellent image can also be formed with the image forming apparatus 1000′ in FIG. 10. A description of the charging device 65 and the cleaning member 21 arranged in the charging device 65 is omitted (see FIGS. 2 to 4 and descriptions of these figures).

The image forming apparatuses 1000 and 1000′ described above are color-image forming apparatuses, but the image forming apparatus of the invention may be a monochromatic image forming apparatus. Hereinafter, the monochromatic image forming apparatus in still another embodiment of the image forming apparatus of the invention, and a process cartridge which is used in this monochromatic image forming apparatus and corresponds to another embodiment of the process cartridge of the invention, are described.

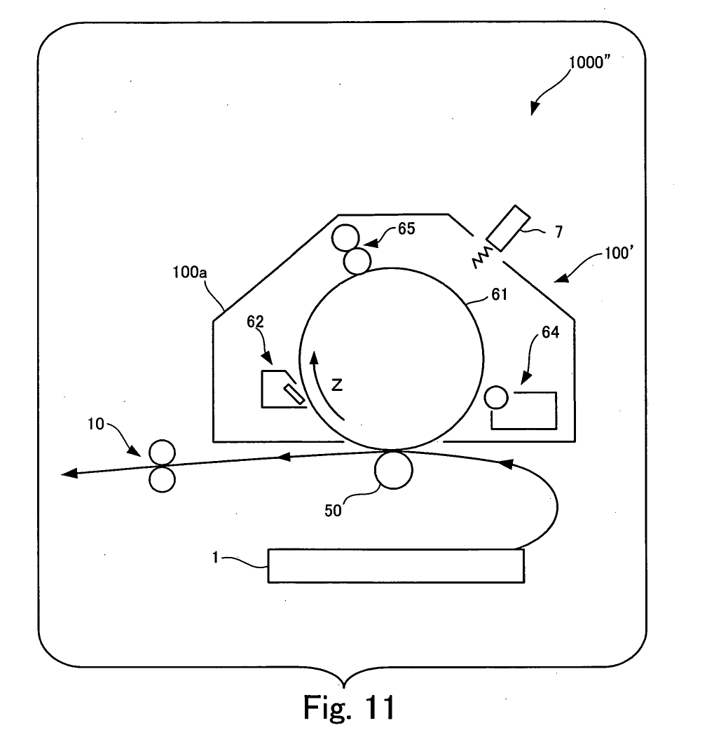

FIG. 11 is the whole block diagram of a monochromatic image forming apparatus corresponding to still another exemplary embodiment of the image forming apparatus of the invention.

The image forming apparatus 1000″ shown in FIG. 11 is a single-side output color printer using an electrophotographic system. In FIG. 11, the same constituent elements as those of the image forming apparatus 1000 in FIG. 1 are denoted by the same reference numerals. The image forming apparatus 1000″ in FIG. 11 is provided with an image carrier 61 that rotates in the arrowed direction Z in this figure and with a charging device 65 that charges the image carrier 61 by rotating and contacting with the image carrier 61. The image carrier 61 and the charging device 65 are the same as the image carriers 61K, 61C, 61M and 61Y (that is, the image carrier 61 shown in FIGS. 2 and 5) and the charging devices 65K, 65C, 65M and 65Y (that is, the charging device 65 shown in FIGS. 2 and 3) in the image developing apparatus 1000 in FIG. 1. The image forming apparatus 1000″ is also provided with a light exposure section 7 that emits a laser light to the image carrier 61 to form, on the image carrier 61, an electrostatic latent image of higher potential than its surrounding area, a developing device 64 that develops the electrostatic latent image with a monochromatic (black) toner to form a developed image, a transfer roll 50 that transfers the developed image by pressing a delivered paper against the image carrier 61 having the developed image formed thereon, a fixing device 10 that fixes the transferred image on the paper by heating and pressurizing the transferred image on the paper, and a cleaning device 62 that contacts with the image carrier 61 and cleans residual materials such as residual toner and external additive particles adhering to the image carrier 61 after transfer of the developed image. In the image forming apparatus 1000″, both the charging device 65 and the image carrier 61 are in the form of a roll extending in a direction perpendicular to FIG. 11, and both ends of the roll are supported with a support member 110a such that the roll is rotatable. The cleaning device 62 and the developing device 64 are also connected to the support member 100a, and the charging device 65, the image carrier 61, the cleaning device 62 and the developing device 64 are thus integrated into the support member 100a thereby forming the process cartridge 100′. The process cartridge 100′ is integrated in the image forming apparatus 1000″, whereby the respective parts that the constituent components of the process cartridge 100′ are arranged in the image forming apparatus 1000″. The process cartridge 100′ corresponds to one exemplary embodiment of the process cartridge of the invention.

The image forming apparatus 1000″ is provided with a toner cartridge (not shown) accommodating a black toner, and this toner cartridge replenishes the developing device 64 with the toner. The paper used in transfer of a developed image is stored in tray 1, and when image formation is instructed by the user, the paper is delivered from tray 1, and a developed image is transferred thereto in the transfer roll 50 and then delivered leftward in the figure. In FIG. 11, the paper path is shown as a path indicated by a left-pointing arrow, and the paper passes through this paper path, and the transferred image transferred on the paper is fixed in the fixing device 10 and then discharged leftward.

The image forming apparatus 1000′ in FIG. 11 is also provided with the charging device 65 shown in FIGS. 2 and 3, whereby the charging member 20 possessed by the charging device 65 (see FIGS. 2 and 3) is smoothly cleaned with the cleaning member 21 (see FIGS. 2 and 3) thereby preventing image defects caused due to vibration of the cleaning member 21. As a result, an excellent image can be formed with the image forming apparatus 1000′ in FIG. 11. A description of the charging device 65 and the cleaning member 21 arranged in the charging device 65 is omitted (see FIGS. 2 to 4 and a description of these figures).

Hereinafter, specific examples and comparative examples are provided to demonstrate that the destabilization of the charging performance of the charging device, and image defects generated by vibration of the charging device, can be suppressed by providing the image forming apparatus with the charging device described above.

### EXAMPLE 1

The image forming apparatus used in Example 1 is the same as the image forming apparatus 1000 in FIG. 1 except that the following charging member and cleaning member are used as the charging member 20 and cleaning member 21 in the charging device 65 and the image carrier which is the same as the image carrier 61 except that it lacks the protective layer 614 is used in place of the image carrier 61.

### —Cleaning Member—

The cleaning member used in Example 1 is provided with both a cleaning roll body consisting of a foamed polyurethane material (trade name: RR80, manufactured by INOAC CORPORATION) formed into a roll and a cleaning shaft of stainless steel (JIS G4303-1998: SUS303) having an external diameter φ of 5 mm and a length of 230 mm. This cleaning roll body is attached via a hot-melt adhesive onto the periphery of the cleaning roll shaft except in both 5-mm ends of the cleaning roll shaft, and the external diameter φ of the cleaning roll body is 9 mm. The average diameter of pores (cell diameter) on the surface of the cleaning roll body is 500 μm. A covering film is formed on the surface of the cleaning roll body by the following method to complete a cleaning member.

First, 100 parts by weight of a polyurethane resin (trade name: Bihydrol XP2429, manufactured by Sumitomo Bayer Urethane Co., Ltd.) as a resin of the covering film body, 30 parts by weight of an isocyanate resin (trade name: Bihydule 3100, manufactured by Sumitomo Bayer Urethane Co., Ltd.) as a crosslinking agent, and 10 parts by weight of a carbon black dispersion (trade name: EP510 BLACK, manufactured by Dainichiseika Colour & Chemicals Mfg. Co., Ltd.) are mixed to prepare a covering film-forming coating liquid.

Then, the cleaning roll body attached via an adhesive to the cleaning roll shaft is dipped in the coating liquid in a container and sonicated until air bubbles are not generated from the cleaning roll body.

Then, the cleaning roll body and cleaning roll shaft covered with the coating liquid is raised from the container and placed in a drying oven at 150° C. for 30 minutes according to a system described in the above-mentioned “Kakyozai Handbook” (Crosslinking Agent Handbook) (edited by Shinzo Yamashita & Tosuke Kaneko and published by Taiseisha (1981)), to cause chemical reaction so as to have a crosslinked structure. The degree of crosslinkage as determined by the method described above is 88%.

With respect to the cleaning member used in Example 1, the resin of the covering film body, the type and amount of the crosslinking agent in the covering film, the amount of the carbon black dispersion in the covering film, the degree of crosslinking in the covering film, and the cell diameter and shape of the cleaning member are shown in Table 2 below.

TABLE 2

| | | | | | Cell | | | | |
|---|---|---|---|---|---|---|---|---|---|
| | | | | | diameter | | | Image qualities | |
| | Covering film of the cleaning member | | | | (μm) | Shape | | At the start | At the end |
| | | | | Degree of | of the | of the | Charg- | of | of |
| | Resin of the | | Amount of carbon | crosslinking | cleaning | cleaning | ing | continuous | continuous |
| | body | Crosslinking agent | black dispersion | (%) | member | member | roll | output | output |
| Example 1 | Polyurethane | 30 parts by weight of | 10 parts by weight | 88 | 500 | Roll | C | VG | VG |
| Example 2 | Polyester | isocyanate resin | | 92 | | | | VG | VG |
| Example 3 | Acrylic | | | 86 | | | | VG | VG |
| Example 4 | Epoxy | | | 79 | | | | VG | VG |
| Example 5 | Polyamide | | | 67 | | | | VG | VG |
| Example 6 | Polyurethane | | | 88 | | Pad | | VG | G |
| Example 7 | | | | | | Roll | B | VG | VG |
| Example 8 | | | | | | | A | VG | VG |
| Example 9 | | | 0.2 part by weight | | 120 | | C | VG | VG |
| Example 10 | | | | | 980 | | | VG | G |
| Example 11 | | | | | 500 | | | VG | VG |
| Example 12 | Epoxy | 20 parts by weight of | | 79 | | | | VG | G |
| | | amino resin | | | | | | | |
| Example 13 | Polyamide | 30 parts by weight of | | 67 | | | | VG | G |
| Example 14 | Acrylic | melamine resin | | 86 | | | | VG | G |
| Example 15 | Polyester | 10 parts by weight of | 10 parts by weight | 25 | | | | VG | P |
| | | isocyanate resin | | | | | | | |
| Comparative | None | | | | 500 | | | VG | P |
| Example 1 | | | | | | | | | |
| Comparative | | | | | 120 | | | VG | VP |
| Example 2 | | | | | | | | | |
| Comparative | | | | | 980 | | | VP | VP |
| Example 3 | | | | | | | | | |
| Comparative | | | | | 80 | | | P | VP |
| Example 4 | | | | | | | | | |

Note
VG: very good,
G: good,
VP: very poor,
P: poor

### —Charging Member—

The charging member used in Example 1 is formed by covering the periphery of a shaft having an external diameter φ of 8 mm and a length of 240 mm (SUM subjected to electroless nickel plating) with a charging roll. This charging roll is attached via a phenolic electroconductive adhesive onto the above shaft. This charging roll consists of an elastic layer and a surface layer, and the composition and thickness of these layers are as shown in the column Compounding amount C in Table 3 below. The elastic layer of this charging,roll also plays the role of the elastic layer 201 in FIG. 3, and the surface layer of this charging roll plays the role of 2 layers that are the resistance layer 202 and the surface layer 20 in FIG. 3. In Table 2, it is described that the charging roll used in Example 1 has the composition and layer thickness shown in the column Compounding amount C.

TABLE 3

| | | | | Compounding amount | | | | | |
|---|---|---|---|---|---|---|---|---|---|
| | | | Material type | A | | B | | C | |
| Elastic | Composition | Rubber | Epichlorohydrin | 96.4 | phr | 75 | phr | 96.4 | phr |
| layer | | | NBR | 4.4 | phr | 25 | phr | 4.4 | phr |
| | | Electroconductive | Quaternary ammonium salt | 0.9 | phr | — | | — | |
| | | material | “benzyltriethyl ammonium chloride” | | | | | | |
| | | | PEL | — | | 0.8 | phr | — | |
| | | | Lithium perchlorate | — | | — | | 3 | phr |
| | | Electroconductive | Carbon black | 15 | phr | 10 | phr | 15 | phr |
| | | agent/reinforcing | | | | | | | |
| | | agent | | | | | | | |
| | | Vulcanizing agent | Sulfur | 0.5 | phr | 0.5 | phr | 0.5 | phr |
| | | | Sulfer disulfide | 1.6 | phr | — | | 1.6 | phr |
| | | | Peroxide | — | | 5 | phr | — | |
| | | Vulcanization | TT (tetramethylthiuram disulfide) | 1.5 | phr | 1.5 | phr | 1.5 | phr |
| | | accelerator | DM (dibenzothiazyl disulfide) | 1.5 | phr | 1.5 | phr | 1.5 | phr |
| | | Filler | Calcium carbonate | 20 | phr | — | | 20 | phr |
| | | | Si powder | — | | 20 | phr | — | |
| | | Vulcanization | Stearic acid | 1 | phr | 1 | phr | 1 | phr |
| | | accelerator/activator | Zinc white (zinc oxide) | 5 | phr | 5 | phr | 5 | phr |
| | Thickness | | | 3 | mm | 3 | mm | 3 | mm |
| Surface | Composition | Resin | Melamine | 342 | g | 342 | g | 342 | g |
| layer | | | DIC “Super Bekkamine G821-6” | | | | | | |
| | | | Polyester | 1300 | g | 1300 | g | 1300 | g |
| | | | Toyobo “VYLON 30SS” | | | | | | |
| | | Electroconductive | Carbon black | 10 | wt % | 10 | wt % | 10 | wt % |
| | | material | Degussa “FW200” | | | | | | |
| | | Lubricant | Fluorine resin | 200 | g | 200 | g | 200 | g |
| | | | Daikin Industries “LUBRON L-2” | | | | | | |

| | | | | | | |
|---|---|---|---|---|---|---|
| Thickness | 15 | μm | 15 | μm | 20 | μm |

DIC “Super Bekkamine G821-6”: trade name: G821-6, manufactured by DIC corporation.
Toyobo “VYLON 30SS”: trade name: VYLON 30SS, manufactured by TOYOBO Co., Ltd.
Degussa “FW200”: trade name: Color Black FW200, manufactured by Degussa AG
Daikin Industries “LUBRON L-2”: trade name: LUBRON L-2, manufactured by Daikin Industries Ltd

### —Image-Bearing Body—

The image carrier used in Example 1 is an image carrier produced by the following method.

First, a cylindrical aluminum base material having an external diameter φ of 84 mm subjected to honing treatment is prepared.

Then, 100 parts by weight of a zirconium compound (trade name: Orgatics ZC540, manufactured by Matsumoto Chemical Co., Ltd.), a silane compound (trade name: A-1100, manufactured by Nippon Unicar Co., Ltd.), 400 parts by weight of isopropanol and 200 parts by weight of butanol are mixed to prepare an undercoat layer-forming coating liquid. This coating liquid is applied by dipping onto the aluminum base material and then dried by heating at 150° C. for 10 minutes to form an undercoat layer of 0.1 μm in thickness.

Subsequently, 1 part by weight of hydroxy gallium phthalocyanine having strong diffraction peaks at Bragg angles (2θ±0.2°) of 7.5°, 9.9°, 12.5°, 16.3°, 18.6°, 25.1° and 28.3° on a CuKα-characteristic X-ray diffraction spectrum, 1 part by weight of polyvinylbutyral (trade name: S-LEC BM-S, manufactured by Sekisui Chemical Co., Ltd.) and 100 parts by weight of n-butyl acetate are mixed and then dispersed in a paint shaker along with glass beads therein for 1 hour, to give a charge-generating layer-forming coating liquid. The coating solution is applied by dipping onto the aforementioned undercoat layer and then dried by heating at 100° C. for 10 minutes to form a charge-generating layer having a thickness of about 0.15 μm.

Then, 2 parts by weight of a charge-transporting material represented by formula (VII) below, 3 parts by weight of a polymer compound (viscosity-average molecular weight 50,000) having the structural unit represented by formula (VIII) below and 20 parts by weight of chlorobenzene are mixed to prepare a charge-transporting layer-forming coating liquid. The charge-transporting layer-forming coating solution thus obtained is applied by dipping onto the aforementioned charge-generating layer and then dried by heating at 110° C. for 40 minutes to form a charge-transporting layer having a thickness of 20 μm. In this manner, an image carrier having the undercoat layer, the charge-generating layer and the charge-transporting layer formed on the aluminum base material subjected to honing treatment is prepared.

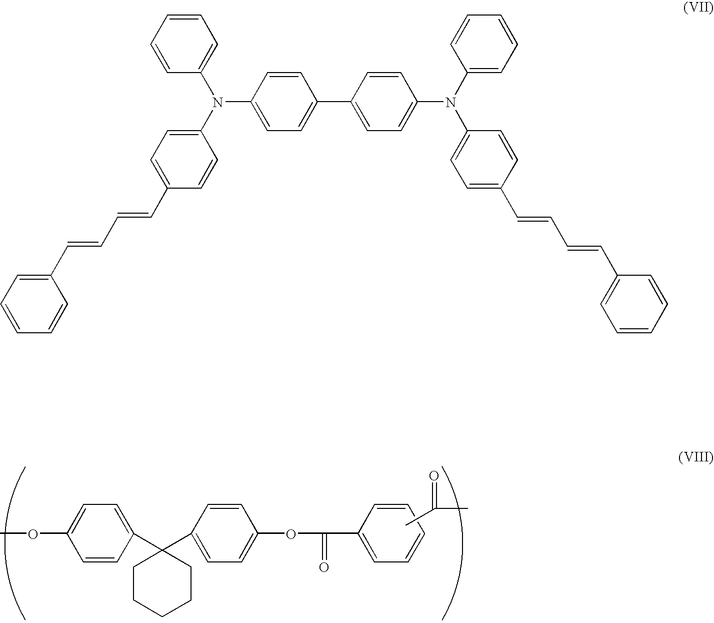

An output test of continuously outputting a predetermined monochromic halftone image on 100,000 sheets of paper is carried out with the image forming apparatus in Example 1. In this output test, the image carrier is charged in a DC voltage system with a charging voltage of −800 V.

An image outputted at the start of continuous output and an image outputted at the end of continuous output are visually examined for the degree of image disturbance. The image disturbance is an image defect occurring frequently when the charging performance of the charging device is destabilized or when the charging device is vibrated. Accordingly, the cleaning performance of the cleaning member that cleans the charging member, and the extent of vibration of the charging device, can be examined by checking the influence of image disturbance on image qualities. Particularly at the end of continuous output, the image carrier has been repeatedly charged, and thus foreign substances such as abrasive powder in the cleaning member may have been friction-charged to adhere easily to the surface of the charging member, to cause a reduction in the charging performance of the charging member. Evaluation of image qualities is carried out under the following categories:
Very good (VG): no image disturbance
Good (G): very slight image disturbance to such an extent that image qualities are not problematic at all.
Fair (F): image disturbance to such an extent that image qualities are not considerably problematic.
Poor (P): image disturbance to such an extent that image qualities are problematic.
Very poor (VP): image disturbance to such an extent that image qualities are extremely problematic.

The results of the output test with the image forming apparatus in Example 1 are shown in Table 2.

### EXAMPLE 2

The image forming apparatus in Example 2 is the same as the image forming apparatus as in Example 1 except that the image forming apparatus has a different constitution of the covering film of the cleaning member. The covering film of the cleaning member in Example 2 is different from the covering film in Example 1 in that the degree of crosslinkage of the covering film becomes 92% by using 100 parts by weight of a polyester resin (trade name: MD1400, manufactured by Toyobo Co., Ltd.) as a resin of the covering film body, and the other features of the covering film are the same as those of the covering film in Example 1.

For the charging device used in Example 2, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 2 is examined in the same output test as in Example 1. The results of the output test with the image forming apparatus in Example 2 are shown in Table 2.

### EXAMPLE 3

The image forming apparatus in Example 3 is the same as the image forming apparatus as in Example 1 except that the image forming apparatus has a different constitution of the covering film of the cleaning member. The covering film of the cleaning member in Example 3 is different from the covering film in Example 1 in that that the degree of crosslinkage of the covering film becomes 86% by using 100 parts by weight of an acrylic resin (trade name: Bihydrol VPLS2058, manufactured by Sumitomo Bayer Urethane Co., Ltd.) as a resin of the covering film body, and the other features of the covering film are the same as those of the covering film in Example 1.

For the charging device used in Example 3, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 3 is examined in the same output test as in Example 1. The results of the output test with the image forming apparatus in Example 3 are shown in Table 2.

### EXAMPLE 4

The image forming apparatus in Example 4 is the same as the image forming apparatus as in Example 1 except that the image forming apparatus has a different constitution of the covering film of the cleaning member. The covering film of the cleaning member in Example 4 is different from the covering film in Example 1 in that the degree of crosslinkage of the covering film becomes 79% by using 100 parts by weight of an epoxy resin (trade name: EM-101-50, manufactured by ADEKA Co., Ltd.) as a resin of the covering film body, and the other features of the covering film are the same as those of the covering film in Example 1.

For the charging device used in Example 4, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 4 is examined in the same output test as in Example 1. The results of the output test with the image forming apparatus in Example 4 are shown in Table 2.

### EXAMPLE 5

The image forming apparatus in Example 5 is the same as the image forming apparatus as in Example 1 except that the image forming apparatus has a different constitution of the covering film of the cleaning member. The covering film of the cleaning member in Example 5 is different from the covering film in Example 1 in that the degree of crosslinkage of the covering film becomes 67% by using 100 parts by weight of a polyamide resin (trade name: Tresin EF30T, manufactured by Nagase ChemteX Corporation) as a resin of the covering film body, and the other features of the covering film are the same as those of the covering film in Example 1.

For the charging device used in Example 5, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 5 is examined in the same output test as in Example 1. The results of the output test with the image forming apparatus in Example 5 are shown in Table 2.

### EXAMPLE 6

The image forming apparatus in Example 6 is the same as the image forming apparatus as in Example 1 except that the image forming apparatus has a different shape of the cleaning member. The cleaning member in Example 6 is in the form of a pad, and the cleaning member in Example 6 is produced by forming the same covering film as in Example 1 on a cleaning member body consisting of the above-mentioned “RR80” in Example 1 (manufactured by INOAC CORPORATION) formed into a pad of 20 mm×20 mm×250 mm.

For the charging device used in Example 6, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 6 is examined in the same output test as in Example 1. The results of the output test with the image forming apparatus in Example 6 are shown in Table 2.

### EXAMPLE 7

The image forming apparatus in Example 7 is the same as the image forming apparatus in Example 1 except that the image forming apparatus is different in the type of the charging roll (see Table 3). The charging roll in Example 7 consists of an elastic layer and a surface layer, and the composition and thickness of these layers are as shown in the column Compounding amount B in Table 3.

For the charging device used in Example 7, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 7 is examined in the same output test as in Example 1. The results of the output test with the image forming apparatus in Example 7 are shown in Table 2.

### EXAMPLE 8

The image forming apparatus in Example 8 is the same as the image forming apparatus in Example 1 except that the image forming apparatus is different in the type of the charging roll (see Table 3). The charging roll in Example 8 consists of an elastic layer and a surface layer, and the composition and thickness of these layers are as shown in the column Compounding amount A in Table 3.

For the charging device used in Example 8, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 8 is examined in the same output test as in Example 1. The results of the output test with the image forming apparatus in Example 8 are shown in Table 2.

When an image forming apparatus which is the same as the image forming apparatus in Example 8 except that the image carrier further has a protective layer arranged on the outermost layer thereof (see FIG. 5) is examined in the same output test, absolutely the same results as in Example 8 are obtained. This image carrier having a protective layer is produced by the same method for manufacturing an image carrier as described in Example 1 except that the method further comprises a step of arranging a protective layer as follows.

7 parts by weight of a resol-type phenolic resin (trade name; PL-2211, manufactured by Gunei Chemical Industry Co., Ltd.) and 0.03 part by weight of methyl phenyl polysiloxane are prepared and dissolved in a mixed solvent of 15 parts by weight of isopropanol and 5 parts by weight of methyl ethyl ketone to prepare a protective layer-forming coating liquid. This coating liquid is applied onto the charge-transporting layer by the dipping coating method and then dried at 130° C. for 40 minutes to form a protective layer of 3 μm in thickness.

### EXAMPLE 9

The image forming apparatus in Example 9 is the same as the image forming apparatus in Example 1 except that the image forming apparatus is different in the amount of the carbon black dispersion contained in the covering film of the cleaning member and also in the cell diameter of the cleaning member. This covering film of the cleaning member in Example 9 contains 0.2 part by weight of the carbon black dispersion, and except for this features, the covering film of the cleaning member in Example 9 is the same as the covering film of the cleaning member in Example 1. The cleaning member in Example 9 makes use of a cleaning roll body wherein a foamed polyurethane material “RSC” (manufactured by INOAC CORPORATION) formed into a roll is used in place of “RR80” (manufactured by INOAC CORPORATION) in Example 1, and the cell diameter is 120 μm.

For the charging device used in Example 9, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 9 is examined in the same output test as in Example 1. The results of the output test with the image forming apparatus in Example 9 are shown in Table 2.

### EXAMPLE 10

The image forming apparatus in Example 10 is the same as the image forming apparatus in Example 1 except that the image forming apparatus is different in the amount of the carbon black dispersion contained in the covering film of the cleaning member and also in the cell diameter of the cleaning member. This covering film of the cleaning member in Example 10 contains 0.2 part by weight of the carbon black dispersion, and except for this feature, the covering film of the cleaning member in Example 10 is the same as the covering film of the cleaning member in Example 1. The cleaning member in Example 10 is a cleaning member having a cell diameter of 980 μm produced in the following manner.

First, 100 parts by weight of polyether polyol (trade name: SANNIX FA226, manufactured by Sanyo Chemical Industries, Ltd.), 1 part by weight of a silicone-based foam stabilizer (trade name: SZ-1142, manufactured by Nippon Unicar Co., Ltd.), 20 parts by weight of water as a foaming agent, 0.2 part by weight of a catalyst bis(2-dimethylaminoethyl) ether (trade name: TOYOCAT-ET, manufactured by Tosoh Corporation), 0.2 part by weight of a catalyst tin octylate (manufactured by Chukyo Yushi Co., Ltd.), and 47 parts by weight of tolylene diisocyanate (TDI) (trade name: T-80, manufactured by Nippon Polyurethane Co., Ltd.) are mixed at a temperature of 25° C. for 10 seconds by means of a high-speed stirring device. Then, the resulting mixture is transferred onto a metallic tray, foamed and left overnight at room temperature to give an urethane foam. The resulting urethane foam is formed in the same size as that of the cleaning roll body in Example 1 and attached via a hot-melt adhesive onto the periphery of the same cleaning roll shaft as in Example 1. Then, a covering film is formed in the same manner as in Example 1.

For the charging device used in Example 10, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 10 is examined in the same output test as in Example 1. The results of the output test with the image forming apparatus in Example 10 are shown in Table 2.

### EXAMPLE 11

The image forming apparatus in Example 11 is the same as the image forming apparatus in Example 1 except that the image forming apparatus is different in the amount of the carbon black dispersion contained in the covering film of the cleaning member. This covering film of the cleaning member in Example 11 contains 0.2 part by weight of the carbon black dispersion, and except for this feature, the covering film of the cleaning member in Example 11 is the same as the covering film of the cleaning member in Example 1.

For the charging device used in Example 11, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 11 is examined in the same output test as in Example 1. The results of the output test with the image forming apparatus in Example 11 are shown in Table 2.

### EXAMPLE 12

The image forming apparatus in Example 12 is the same as the image forming apparatus in Example 1 except that the image forming apparatus is different in the constitution of the covering film of the cleaning member. This covering film of the cleaning member in Example 12 is different from the covering film in Example 1 in that the degree of crosslinkage of the covering film becomes 79% by using 100 parts by weight of an epoxy resin (trade name: EM-101-50, manufactured by ADEKA Co., Ltd.) as a resin of the covering film body, 20 parts by weight of a benzoguanamine resin (trade name: Nikalac BL-60, manufactured by Nippon Carbide Industries Co., Inc.) as a crosslinking agent, and 0.2 part by weight of the carbon black dispersion in the covering film, and the other features of the covering film are the same as those of the covering film in Example 1.

For the charging device used in Example 12, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 12 is examined in the same output test as in Example 1. The results of the output test with the image forming apparatus in Example 12 are shown in Table 2.

### EXAMPLE 13

The image forming apparatus in Example 13 is the same as the image forming apparatus in Example 1 except that the image forming apparatus is different in the constitution of the covering film of the cleaning member. This covering film of the cleaning member in Example 13 is different from the covering film in Example 1 in that the degree of crosslinkage of the covering film becomes 67% by using 100 parts by weight of a polyamide resin (trade name: Tresin EF30T, manufactured by Nagase ChemteX Corporation) as a resin of the covering film body, 30 parts by weight of a melamine resin (trade name: Nikalac MW-30M, manufactured by Nippon Carbide Industries Co., Inc.) as a crosslinking agent, and 0.2 part by weight of the carbon black dispersion in the covering film, and the other features of the covering film are the same as those of the covering film in Example 1.

For the charging device used in Example 13, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 13 is examined in the same output test as in Example 1. The results of the output test with the image forming apparatus in Example 13 are shown in Table 2.

### EXAMPLE 14

The image forming apparatus in Example 14 is the same as the image forming apparatus in Example 1 except that the image forming apparatus is different in the constitution of the covering film of the cleaning member. This covering film of the cleaning member in Example 14 is different from the covering film in Example 1 in that the degree of crosslinkage of the covering film becomes 86% by using 100 parts by weight of an acrylic resin (trade name: Bihydrol VPLS2058, manufactured by Sumitomo Bayer Urethane Co., Ltd.) a resin of the covering film body, 30 parts by weight of a melamine resin (trade name: Nikalac MW-30M, manufactured by Nippon Carbide Industries Co., Inc.) as a crosslinking agent, and 0.2 part by weight of the carbon black dispersion in the covering film, and the other features of the covering film are the same as those of the covering film in Example 1.

For the charging device used in Example 14, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 14 is examined in the same output test as in Example 1. The results of the output test with the image forming apparatus in Example 14 are shown in Table 2.

### EXAMPLE 15

The image forming apparatus in Example 15 is the same as the image forming apparatus in Example 1 except that the image forming apparatus is different in the constitution of the covering film of the cleaning member. This covering film of the cleaning member in Example 15 is different from the covering film in Example 1 in that the degree of crosslinkage of the covering film becomes 25% by using 100 parts by weight of a polyester resin (trade name: MD1400, manufactured by Toyobo) as a resin of the covering film body and 10 parts by weight of an isocyanate resin (trade name: Bihydule 3100, manufactured by Sumitomo Bayer Urethane Co., Ltd.) a crosslinking agent, and the other features of the covering film are the same as those of the covering film in Example 1.

For the charging device used in Example 15, the resin of the covering film body, the type and amount of the crosslinking agent in the covering film, the amount of the carbon black dispersion in the covering film, the degree of crosslinkage in the covering film, the cell diameter and shape of the cleaning member, and the type of the charging roll (see Table 3) are shown in Table 2.

The image forming apparatus in Example 15 is examined in the same output test as in Example 1. The results of the output test with the image forming apparatus in Example 15 are shown in Table 2.

### COMPARATIVE EXAMPLE 1

The image forming apparatus in Comparative Example 1 is the same as the image forming apparatus in Example 1 except that the image forming apparatus is lacking the covering film in the cleaning member.

For the charging device used in Comparative Example 1, the cell diameter and shape of the cleaning member and the type of the charging roll (see Table 3) are shown in Table 2.

The image forming apparatus in Comparative Example 1 is examined in the same output test as in Example 1. The results of the output test with the image forming apparatus in Comparative Example 1 are shown in Table 2.

### COMPARATIVE EXAMPLE 2

The image forming apparatus used in Comparative Example 2 is the same as the image forming apparatus in Example 9 except that the image forming apparatus is lacking the covering film in the cleaning member.

For the charging device used in Comparative Example 2, the cell diameter and shape of the cleaning member and the type of the charging roll (see Table 3) are shown in Table 2.

The image forming apparatus in Comparative Example 2 is examined in the same output test as in Example 1. The results of the output test with the image forming apparatus in Comparative Example 2 are shown in Table 2.

### COMPARATIVE EXAMPLE 3

The image forming apparatus in Comparative Example 3 is the same as the image forming apparatus in Example 10 except that the image forming apparatus is lacking the covering film in the cleaning member.

For the charging device used in Comparative Example 3, the cell diameter and shape of the cleaning member and the type of the charging roll (see Table 3) are shown in Table 2.

The image forming apparatus in Comparative Example 3 is examined in the same output test as in Example 1. The results of the output test with the image forming apparatus in Comparative Example 3 are shown in Table 2.

### COMPARATIVE EXAMPLE 4

The image forming apparatus in Comparative Example 4 is the same as the image forming apparatus in Example 1 except that the image forming apparatus is lacking the covering film in the cleaning member, and also that the cleaning member has a cell diameter of 80 μm. The cleaning member used in Comparative Example 4 is a cleaning member produced in the following manner.

First, 100 parts by weight of polyether polyol (trade name: SANNIX FA226, manufactured by Sanyo Chemical Industries, Ltd.), 5 parts by weight of a silicone-based foam (trade name: SZ-1142, manufactured by Nippon Unicar Co., Ltd.), 4 parts by weight of water as a foaming agent, 0.2 part by weight of bis(2-dimethylaminoethyl) ether (trade name: TOYOCAT-ET, manufactured by Tosoh Corporation) as a catalyst, 0.2 part by weight of tin octylate (manufactured by Chukyo Yushi Co., Ltd.) as a catalyst, and 47 parts by weight of tolylene diisocyanate (TDI) (trade name: T-80, manufactured by Nippon Polyurethane Co., Ltd.) are mixed at a temperature of 25° C. for 10 seconds by means of a high-speed stirring device. Then, the resulting mixture is transferred onto a metallic tray, foamed and left overnight at room temperature to give an urethane foam. The resulting urethane foam was formed in the same size as that of the cleaning roll body in Example 1 and attached via a hot-melt adhesive onto the periphery of the same cleaning roll shaft as in Example 1.

For the charging device used in Comparative Example 4, the cell diameter and shape of the cleaning member and the type of the charging roll (see Table 3) are shown in Table 2.

The image forming apparatus in Comparative Example 4 is examined in the same output test as in Example 1. The results of the output test with the image forming apparatus in Comparative Example 4 are shown in Table 2.

### Results

The comparison between Example 1 and Comparative Example 1 wherein the conditions in Example 1 are the same as in Comparative Example 1 except that the covering film is present in the cleaning film reveals that in Comparative Example 1 lacking the covering film, there occurs image disturbance to such an extent that image qualities are problematic at the end of continuous output (evaluation: poor (P)), while in Example 1 with the covering film, there occurs no image disturbance at the end of continuous output (evaluation: very good (VG)). Similarly, the comparison between Example 9 and Comparative Example 2 wherein the conditions in Example 9 are the same as in Comparative Example 2 except that the covering film is present in the cleaning film reveals that in Comparative Example 2 lacking the covering film, there occurs image disturbance to such an extent that image qualities are extremely problematic at the end of continuous output (evaluation: very poor (VP)), while in Example 9 with the covering film, there occurs no image disturbance at the end of continuous output (evaluation: very good (VG)). Similarly, the comparison between Example 10 and Comparative Example 3 wherein the conditions in Example 10 are the same as in Comparative Example 3 except that the covering film is present in the cleaning film reveals that in Comparative Example 3 lacking the covering film, there occurs image disturbance to such an extent that image qualities are extremely problematic both at the start of continuous output and at the end of continuous output (evaluation: very poor (VP)), while in Example 10 with the covering film, there occurs no image disturbance at the start of continuous output (evaluation: very good (VG)) and there occurs very slight image disturbance to such an extent that image qualities are not problematic at all even at the end of continuous output (evaluation: good (G)). The comparison between Example 1 and Comparative Example 1, the comparison between Example 9 and Comparative Example 2 and the comparison between Example 10 and Comparative Example 3 reveal that the vibration of the charging device can be suppressed and simultaneously the cleaning performance of the cleaning member can be improved by providing the covering film as shown in Examples 1, 9 and 10.

When the results of Examples 1, 2, 3 and 5 that are different only in the type of the resin in the covering film and thus in the degree of crosslinking are taken into consideration, the degree of crosslinking in any of these examples reaches 65% or more, and there occurs no inage disturbance both at the start of continuous output and at the end of continuous output (evaluation: very good (VG)). The comparison between Example 2 and Example 15 which are different only in the type of the resin of the crosslinking agent and thus in the degree of crosslinking reveals that in Example 15 wherein the degree of crosslinking is 25% (that is, below 65%), there occurs very slight image disturbance to such an extent that image qualities are not problematic at all at the end of continuous output (evaluation is good (G)), while in Example 2 wherein the degree of crosslinking is 92%, there occurs no image disturbance even at the end of continuous output (evaluation: very good (VG)). The comparison among Examples 1, 2, 3, 4, 5 and 15 that are different from one another in respect of the degree of crosslinking reveals that the degree of crosslinking is preferably 65% or more.

The comparison among Examples 9, 10 and 11 that are different only in the cell diameter of the cleaning member reveals that in Example 10 wherein the cell diameter is 980 μm, there occurs very slight image disturbance at the end of continuous output (evaluation: good (G)), while in Example 9 wherein the cell diameter is 120 μm and in Example 11 wherein the cell diameter is 500 μm, there occurs no image disturbance even at the end of continuous output (evaluation: very good (VG)). The comparison among Comparative Examples 1, 2 and 4 that are different only in the cell diameter of the cleaning member reveals that in Comparative Example 4 wherein the cell diameter is 80 μm, there occurs image disturbance to such an extent that image qualities are problematic even at the start of continuous output (evaluation: poor (P)), while in Comparative Example 2 wherein the cell diameter is 120 μm and in Comparative Example 1 wherein the cell diameter is 500 μm, there occurs no image disturbance at the start of continuous output (evaluation: very good (VG)). The comparison among Examples 9, 10 and 11 and the comparison among Comparative Examples 1, 2 and 4 reveal that the cell diameter of the cleaning member is preferably 100 μm to 1.0 mm, from the viewpoint of cleaning performance.

Then, the comparison between Examples 1 and 6 that are different only in the shape of the cleaning member reveals that in Example 6 wherein the shape of the cleaning member is in the form of a pad, there occurs very slight image disturbance at the end of continuous output (evaluation is good (G)), while in Example 1 wherein the shape of the cleaning member is in the form of a roll, there occurs no image disturbance even at the end of continuous output (evaluation: very good (VG)). From this result, it can be seen that the shape of the cleaning member is preferably in the form of a roll, from the viewpoint of cleaning performance.

Then, the comparison between Examples 4 and 12 that are the same in respect of the crosslinking degree (that is, 79%) but are different in respect of the amount of the carbon black dispersion reveals that in Example 12 wherein the amount of the carbon black dispersion is as low as 0.2 part by weight, there occurs very slight image disturbance at the end of continuous output (evaluation: good (G)), while in Example 4 wherein the amount of the carbon black dispersion is 10 parts by weight, there occurs no image disturbance even at the end of continuous output (evaluation: very good (VG)). The comparison between Examples 5 and 13 that are the same in respect of the crosslinking degree (that is, 67%) but are different in respect of the amount of the carbon black dispersion reveals that in Example 13 wherein the amount of the carbon black dispersion is as low as 0.2 part by weight, there occurs very slight image disturbance at the end of continuous output (evaluation: good (G)), while in Example 5 wherein the amount of the carbon black dispersion is 10 parts by weight, there occurs no image disturbance even at the end of continuous output (evaluation: very good (VG)). The comparison between Examples 3 and 14 that are the same in respect of the crosslinking degree (that is, 86%) but are different in respect of the amount of the carbon black dispersion reveals that in Example 14 wherein the amount of the carbon black dispersion is as low as 0.2 part by weight, there occurs very slight image disturbance at the end of continuous output (evaluation: good (G)), while in Example 3 wherein the amount of the carbon black dispersion is 10 parts by weight, there occurs no image disturbance even at the end of continuous output (evaluation: very good (VG)). The comparison between Example 4 and Example 12, the comparison between Example 5 and Example 13 and the comparison between Example 3 and Example 14 reveal that when the amount of the electroconductive particles is established such that the amount of carbon black is 4 parts by weight and the amount of the carbon black dispersion is 10 parts by weight or more, there is brought about a higher effect of preventing frictional electrification of foreign substances such as abrasive powder.

From the results described above, it can be concluded that by providing the covering film, the vibration of the charging device can be suppressed and simultaneously the cleaning performance of the cleaning member can be improved. It can also be concluded that the covering film having a crosslinking degree of 65% or more, and the cleaning member in the form of a roll having a cell diameter of 100 μm to 1.0 mm, can be used to realize higher cleaning performance. It can also be seen that when carbon black is present in a sufficient amount (that is, 4 parts by weight of carbon black and 10 parts by weight or more of the carbon black dispersion) in the covering film, there can be brought about a higher effect of preventing foreign substances such as abrasive powder from being friction-charged.

The foregoing is a description of exemplary embodiments of the invention.

In the above description, the image forming apparatus outputs an image on one side of paper but the image forming apparatus of the invention may be an apparatus that outputs an image on both sides of paper.

What is claimed is:

1. A charging device comprising:
a charging member that gives an electric charge to an object to be charged by contacting the object; and
a cleaning member that cleans the charging member by contacting the charging member,
wherein the cleaning member comprises a base formed of a polymer material having a foamed structure and a covering film that is formed of a mixture of a resin having a crosslinked structure and electroconductive particles and that covers, near a surface of the base, a structural wall of the formed structure.

2. The charging device according to claim 1, wherein the resin has, as the crosslinked structure, a 3-dimensional crosslinked structure formed by chemical reaction of functional groups chemically reacting by at least one of heat, a light and an electron beam.

3. The charging device according to claim 1, wherein the electroconductive particles are carbon black.

4. The charging device according to claim 1, wherein a degree of crosslinking of the covering film, which represents a weight proportion, based on the weight of the resin in the covering film, of a crosslinking component forming the crosslinked structure, is 65% or more.

5. The charging device according to claim 1, wherein pores exposed to the surface of the base have an average size in the range of 100 μm to 1.0 mm.

6. The charging device according to claim 1, wherein the cleaning member is in the form of a roll.

7. The charging device according to claim 1, wherein the resin comprises at least one selected from among a group consisting of a polyurethane resin, a polyester resin, an acrylic resin, an epoxy resin, and a polyamide resin.

8. A process cartridge comprising:
an image carrier;
a charging member that gives an electric charge to the image carrier by contacting the image carrier; and
a cleaning member that cleans the charging member by contacting the charging member and that comprises a base formed of a polymer material having a foamed structure and a covering film, the covering film being formed of a mixture of a resin with a crosslinked structure and electroconductive particles and covering, near the surface of the base, a structural wall of the formed structure.

9. An image forming apparatus comprising:
an image carrier;
a charging member that gives an electric charge to the image carrier by contacting the image carrier;
a cleaning member that cleans the charging member by contacting the charging member and that comprises a base formed of a polymer material having a foamed structure and a covering film, the covering film being formed of a mixture of a resin having a crosslinked structure and electroconductive particles and covering, near the surface of the base, a structural wall of the formed structure;
an image forming section that forms an electrostatic latent image on the image carrier and develops the electrostatic latent image thereby forming a developed image; and
a transfer fixing section that transfers the developed image from the image carrier and fixes the transferred image to a recording medium.

10. A cleaning member comprising:
a base formed of a polymer material having a foamed structure; and
a covering film that is formed of a mixture of a resin having a crosslinked structure and electroconductive particles and that covers, near the surface of the base, a structural wall of the formed structure.

11. The cleaning member according to claim 10, wherein the resin has, as the crosslinked structure, a 3-dimensional crosslinked structure formed by chemical reaction of functional groups chemically reacting by at least one of heat, a light and an electron beam.

12. The cleaning member according to claim 10, wherein the electroconductive particles are carbon black.

13. The cleaning member according to claim 10, wherein a degree of crosslinking of the covering film, which represents a weight proportion, based on the weight of the resin in the covering film, of a crosslinking component forming the crosslinked structure, is 65% or more.

14. The cleaning member according to claim 10, wherein pores exposed to the surface of the base have an average size in the range of 100 μm to 1.0 mm.

15. The cleaning member according to claim 10, defined as being in the form of a roll.

16. The cleaning member according to claim 10, wherein the resin comprises at least one selected from among a group consisting of a polyurethane resin, a polyester resin, an acrylic resin, an epoxy resin, and a polyamide resin.
